(19) United States
(12) Patent Application Publication
(10) Pub. No.: US 2025/0271378 A1
(43) Pub. Date: Aug. 28, 2025

(54) DEVICE AND METHOD TO PROBE AN ELECTRICAL PROPERTY OF A MATERIAL IN RELATION TO CHARGE SHARING

(71) Applicant: THE GOVERNING COUNCIL OF THE UNIVERSITY OF TORONTO, Toronto (CA)

(72) Inventors: Xiaoyang CHEN, Richmond Hill (CA); Al-Amin DHIRANI, Toronto (CA)

(21) Appl. No.: 19/042,348

(22) Filed: Jan. 31, 2025

(30) Foreign Application Priority Data
Jan. 31, 2024 (GB) 2401283.3

(51) Int. Cl. G01N 27/02

(52) U.S. Cl. CPC G01N 27/021

(57) ABSTRACT

An improved approach for monitoring or estimating charge exchange mechanisms is proposed where a resistance or an impedance of a material is tracked while the material is subject to electrochemical reactions, such as, but not limited to, oxidation-reduction (redox) reaction. During a redox reaction, there can be evidence of a quantum transition state associated with the redox charge transfer. A monitoring apparatus is disclosed that can be practically implemented in the form of an electrochemical cell adapted for measurement, and the electrochemical cell can be configured as transistor-type apparatus, such as a charge exchange transistor. Different configurations for a dielectric layer are also proposed to aid in enabling hybridization.

### CROSS REFERENCE TO RELATED APPLICATION AND CLAIM OF PRIORITY

The present application claims priority to United Kingdom patent application no. 2401283.3 filed on Jan. 31, 2024, the entire contents of which are hereby incorporated by reference.

### FIELD

Embodiments of the present disclosure generally relate to the field of electrical materials, and more specifically, embodiments relate to devices, systems and methods for probing the electrical property of a material as it participates in a charge sharing process.

### INTRODUCTION

Measurement and control of electronic properties of semiconductors is an important objective, and a related technology described herein is the field effect transistor (FET). Determining these electronic properties can be used in a a variety of practical applications, such as testing, analysis, etc., as the electronic properties can be identified as proxy measurements for the occurrence of other physical phenomena, state changes, reactions, among others.

The field effect transistor (FET) is a three-terminal device consisting of the source, drain and gate electrode. The source and drain electrode are connected by a material whose conductance can be varied electrostatically. An insulating material which acts as a dielectric separates the source-drain material from the gate electrode. A voltage can be applied to the gate electrode which causes charges to accumulate.

An electric field is generated by the accumulated charges and causes the source-drain material to gain/lose charge carriers which could vary the material's conductance. The gate electrode, insulating material and source-drain material collectively form a capacitor; hence, this method of modifying material conductance (gating) is often referred to as electrostatic or capacitive gating. In digital electronics, the source-drain material is often p- or n-doped silicon, the insulating material being silicon dioxide.

Electrostatic gating functions because the electric field of the accumulated charges can shift the Fermi level of the source-drain material. In the case of semiconductors with a band gap, filling the Fermi level to the conduction band causes an increase in conductance and lowering the Fermi level to the band gap makes the material insulating. Naturally, one can replace the source-drain material with a material of interest and use the FET configuration to modify its electronic properties. Two dimensional (2D) materials such as graphene, transition metal dichalcogenides (TMDs) and their heterostructures are often studied using the FET configuration.

### SUMMARY

A proposed device and method are provided that are adapted to probe the electrical property of a material as it participates in a quantum charge sharing process.

In one aspect, the disclosure describes an apparatus for monitoring an impedance or a change in the impedance of a first material having a first material quantum state with a first material electron density distribution and at least one first material quantum energy level, the apparatus configured to receive in proximity with the first material a second material having a second material quantum state with a second material electron density distribution and at least one second material quantum energy level, wherein the first material is selected to have a first material quantum energy level for forming a hybridized quantum state with the second material, the apparatus comprising: a source probe configured for electrical contact with the first material and configured to apply a source electrical signal to the first material; at least one gate electrode, configured to receive at least one gate electrical signal and to generate at least one gate electric field that shifts the at least one first material quantum energy level relative to the at least one second material quantum energy level, thereby modifying a hybridization between the first and second material quantum states and the first and second material electron density distributions; a drain probe configured for electrical contact with the first material and configured to measure a response of the first material to the gate and source electrical signals, at least one of the gate and source electrical signals having an alternating current (AC) component; one or more processors configured to: receive data comprising the response from the drain probe, determine the impedance or the change in the impedance of the first material upon measuring the response of the first material while the first material participates in one or more electrochemical reactions, the impedance or the change in impedance of the first material electrode established at least partially based upon the hybridization between the first material and second material quantum states; determine a material characteristic of the second material based on at least one of the impedance or the change in the impedance of the first material.

In an embodiment, the first material comprises or is coupled with a first dielectric layer adapted for enabling the hybridization of the first and the second material quantum state. In another embodiment, the at least one gate electrode comprises an back gate electrode for inducing a redox change in the second material; wherein the processor is configured to measure a back gate voltage at which the redox change occurs to determine the material characteristic of the second material, wherein the dielectric layer is selected to enable at least one gate electric field to shift the at least one first material quantum energy level relative to the at least one second material quantum energy level for a charge sharing between the first and second material.

In an embodiment, wherein a second dielectric layer is position between the back gate electrode and the first material, wherein the dielectric layer is a solid state material comprising SiO, wherein the back gate comprises silicon and the first material comprises graphene.

In an embodiment, the first material comprises at least one coating comprising a functional group. In another embodiment, the coating comprises at least one of an alkane, a carboxylic acid group, a diazonium functional group, an amine group, an alcohol group, a phenyl group, and a thiol functional group. In another embodiment, the coating comprises at least one: of an n-alkanethiol monolayer, wherein n is greater than equal to 2 and less than equal to 7; thiomalic acid; mercaptobenzoic acid; 2-aminoethanethiol; 3-mercaptopropanol; cysteine; 3-mercaptopropanoic acid; and 11-mercaptoundecanoic acid.

In an embodiment, the coating is configured to position the second material a distance from the first material, wherein the distance between the first material and the second material is less than 10 nm, preferably the distance is less than or equal to 1 nm, more preferably the distance is about 0.5 nm, still more preferably the distance is about 0.25 nm

In an embodiment, the source probe is a first source probe, wherein the at least one gate electrode is at least one first gate electrode, wherein the drain probe is a first drain probe, and wherein the apparatus comprises: a second source probe configured for electrical contact with a third material and configured to apply a source electrical signal to the third material; at least one second gate electrode, configured to receive at least one second gate electrical signal and to generate at least one second gate electric field that shifts the at least one third material quantum energy level relative to the at least one second material quantum energy level, thereby modifying a hybridization between the third and second material quantum states and the third and second material electron density distributions; a second drain probe configured for electrical contact with the third material and configured to measure a response of the third material to the second gate and second source electrical signals, at least one of the second gate and second source electrical signals having an alternating current (AC) component; wherein the processor is configured to: determine the impedance or the change in the impedance of the third material upon measuring the response of the third material while the third material participates in one or more electrochemical reactions the impedance or the change in impedance of the third material electrode established at least partially based upon the hybridization of the third material and the second material quantum states between the third material and the second material; and determine the material characteristic of the second material based on at least one of the impedance or the change in the impedance of the first material and third material.

In an embodiment, the first material has a thickness of less than or equal to 10000 nm, preferably the first material has a thickness of less than or equal to 1000 nm, more preferably the first material has a thickness of less than or equal to 100 nm, still more preferably the first material has a thickness of less than or equal to 10 nm.

In an embodiment, the apparatus comprises a reference electrode in electrical contact with the gate electrode.

In an embodiment, monitoring the impedance or the change in impedance of the first material comprises: monitoring at least one of a conductance, capacitance, and resistance; or a change in the conductance, capacitance, and resistance of the first material.

In an embodiment, determining the material characteristic of the second material comprising identifying the second material.

In an embodiment, the second material comprises at least one of ferrocene, cobaltocene, heavy metals, iron, catalyst poison, and metal ions.

In an embodiment, the first material comprises at least one of transition metal dichalcogenides, graphite, graphene, carbon, platinum, titanium, chromium, and gold.

In an embodiment, the dielectric layer has a complex dielectric constant.

In an embodiment, the dielectric layer has a plurality of thickness profiles across the first material.

In an embodiment, the second material is in a medium. In an example, the medium comprises ions.

In an embodiment, the dielectric layer includes solvent or electrolyte molecules.

In an embodiment, the dielectric layer includes a portion that is a vacuum.

In an embodiment, the first material and the second material are stacked together. In another embodiment, the first material and the second material are stacked together in a form of intercalated graphite.

In an embodiment, the first material includes a chromium adhesion layer.

In an embodiment, the apparatus is incorporated into a measurement circuit. In another embodiment, the measurement circuit is configured to identify one or more resistance peaks. In another embodiment, the measurement circuit is configured to vary the at least one gate electrical signal to trigger the one or more resistance peaks.

In an embodiment, the one or more resistance peaks are converted into an output data set. In another embodiment, the output data set is communicated across a network interface. In another embodiment, the output data set is utilized to generate an actionable output.

In an embodiment, the apparatus is an electrochemical cell. In another embodiment, the electrochemical cell is a charge exchange transistor.

In an embodiment, the resistance or a change in resistance of the first material is monitored.

In an embodiment, the first material includes a catalyst.

In an embodiment, the apparatus comprises a pair of probes configured to measure an AC voltage drop across a portion of the first material.

Embodiments may include combinations of the above features.

In another aspect, the disclosure describes a method of monitoring an impedance or a change in the impedance of a first material, the method comprising: providing the apparatus according to this disclosure; providing the second material in proximity to the first material; applying an AC current to the first material; determining the impedance or the change in the impedance of the first material; determining the material characteristic of the second material.

In an embodiment, the method comprises applying a ramping voltage to the gate electrode.

In an embodiment, the method comprises a report dataset comprising the material characteristic to a task scheduler system for automatic schedule investigation of a test site.

In an embodiment, the material characteristic comprises an amount of the second material, the method comprising: determining if the amount of the second material is greater than a threshold amount of the second material; and issuing an alert.

In an embodiment, the method comprises measuring the impedance at a gate voltage when redox of the second material occurs; and identifying the second material second material based on the measured impedance at the gate voltage.

Embodiments may include combinations of the above features.

Further details of these and other aspects of the subject matter of this application will be apparent from the detailed description included below and the drawings.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is an example schematic diagram showing a circuit diagram of a simple potentiostat using op-amps. FIG. 1 is prior art.

FIG. 2 is a block diagram showing an example CET apparatus, according to some embodiments.

FIG. 3A, FIG. 3B, FIG. 3C, FIG. 3D, FIG. 3E together are a schematic diagram and different expanded views of an example charge exchange transistor, according to some examples.

FIGS. 4A-4F are a set of diagrams depicting charge exchange transistor characterization, ionic liquid gating and metallocene cyclic voltammogram. FIG. 4A is an optical image of charge exchange transistor. Scale bar length: 2 mm.

FIG. 5 shows a simple example of a potential charge transfer mechanism involving such a state

FIGS. 6A-6H are graph plots diagrams that show the effect of changing Fc concentration on CV and WE film normalized resistance vs. voltage. FIG. 6I-6N are graph plot diagrams adapted to show cyclic voltammograms and simultaneously measured working electrode resistance using fc solutions with varying concentrations.

FIGS. 7A-7F are a set of diagrams showing CV and Resistance with n-alkanethiol coated electrodes. FIG. 7G shows a log of anodic and cathodic resistance peaks vs. n. FIG. 7H shows a log of peak-to-peak current in CV vs. n.

FIG. 8A-8F is a set of diagrams showing DFT Modelling for 25 Fc molecules and an Au slab with 490 Au atoms.

FIG. 9 is a plot showing n-hexanethiol self-assembly resistance vs. time for a Au film immersed in a n-hexanethiol solution.

FIGS. 10A-10D show CAD and optical images of a physical property measurement system (PPMS™) compatible sample.

FIGS. 11A and 11B shows cyclic voltammetry and simultaneous resistance measurement of a Au film using 1.0 mM Fc in DEME-TFSI at room temperature.

FIGS. 12A-12D show an example graphene sample characterization.

FIG. 13A and FIG. 13B show cyclic voltammetry and simultaneous resistance measurement of graphene using 1.0 mM cobaltocene in DEME-TFSI at room temperature.

FIGS. 14A-14C is a set of control measurements using an Au film.

FIGS. 15A-15F show cyclic voltammetry and simultaneously measured Au film WE resistance with and without hexanethiol monolayer varying potential sweep rate. FIG. 15G shows a cyclic voltammetry of ferrocene in solution at sweep rates of 50, 100, 200 and 400 mV/s. FIG. 15H-15K are plots showing Normalized film resistance vs. potential. FIG. 15L is a plot of Normalized bare Au film resistance peak magnitude vs Sweep rate.

FIGS. 16A-16C are a set of drawings showing projected density of states (PDOS) for Fe, C and H atoms in an isolated ferrocene molecule calculated using DFT. FIG. 16A is a PDOS for Fe atom.

FIGS. 17A-17C is a set of drawings showing PDOS for Au slabs of different sizes.

### DETAILED DESCRIPTION

A proposed device and method are provided that are adapted to probe the electrical property of a material as it participates in a quantum charge sharing process. The electrical property can include, for instance, a resistance, in a first embodiment, or in a second embodiment, a resistance and reactance (e.g., an impedance), or in a third embodiment, a reactance alone. The electrical property can be a detectable artifact, such as a resistance peak, a reactance peak, or an impedance peak in the property being measured. A number of variations are proposed herein. The electrical property being measured can then be converted into a signal that is utilized for output, or in further embodiments, used for triggering a downstream mechanism (e.g., automatic reduction, shut off).

Gating processes and mechanisms can be quantum mechanical. For example, in a bond between two atoms, at least one electron is in a state that involves a linear combination of both atomic states, and the interaction can be viewed as arising due to charge sharing. In another example, in a Kondo singlet, at least one electron is a hybridized state involving the atom and the metal band as modelled by the Anderson impurity model. Such processes and mechanisms can also be viewed as arising due to quantum charge exchange.

The charge sharing process can include, but is not limited to, bond formation and redox. The proposed device and method can be practically implemented for providing systems for probing an electrical property of a material in relation to charge sharing.

An improved approach for monitoring or estimating charge exchange mechanisms is proposed where a resistance of a thin film electrode is tracked while the thin film electrode is subject to electrochemical reactions, such as, but not limited to, an oxidation-reduction (redox) reaction. During a redox reaction, there can be evidence of a quantum transition state associated with the redox charge transfer.

A monitoring apparatus is disclosed that can be practically implemented in the form of an electrochemical cell adapted for measurement, and the electrochemical cell can be configured as transistor-type apparatus, such as a charge exchange transistor (CET).

The monitoring apparatus can include a source probe and a drain probe. The source probe applies an electrical signal to a first material, the thin film electrode.

A “first material”, the thin film electrode can be considered a “gated material/working electrode” (WE), and could be a thin metal (e.g. Au) film or a monolayer graphene. The thin film electrode is the “working electrode” where reactions take place and can be an inert material that has a defined surface area.

A “counter/gate electrode” is provided and, together with the thin film electrode, can be placed, for example, in an electrolyte solution, a solvent, or an electrolyte solution and a “second material”. The second material can, for example, include redox molecules, such as ferrocene (Fc) and cobaltocene (Cc), and/or various redox species, heavy metals, iron, catalyst poison, and metal ion(s).

The counter electrode can provide a DC current which flows to the drain probe, and/or an AC current can flow in the thin film electrode between the source probe and the drain probe. The DC current provided by the counter electrode can be varied, and the resistance or changes in resistance can be measured during this time duration to characterize the response of the gated material.

The resistance changes can occur during cyclic voltammetry (CV), and this can include a remarkable large transient resistance peak that occurs during both oxidation and reduction that is associated with redox current itself. It is hypothesized that these transient resistance peaks are associated with a quantum transition state.

Accordingly, an apparatus is proposed for monitoring a resistance or a change in resistance of a first material (e.g., graphene) having a first material wavefunction or a first material quantum state with at least one first material quantum energy level. The apparatus is adapted for receiving in proximity with the first material a second material having a second material wavefunction or a second material quantum state with at least one second material energy level.

During experimentation, Applicants observed a technical problem that arises over a period of time where reproduction of the resistance peaks became difficult to control, and hypothesized that these issues arose in respect of accumulation of contamination on the working electrode and impacts on the quantum effect as charge sharing had degraded.

An additional dielectric layer or coating is proposed that helps enable charge sharing by effectively improving quantum wavefunction spatial overlap. The term “wavefunction” means solution to Schrodinger's equation in quantum mechanics. It includes both space-dependent, time-dependent and spin parts. Other terms could be “quantum wavefunction” or “quantum state”. Examples include atomic orbitals, molecular orbitals, band states (for insulators, semi-conductors, semi-metals, metals), superconducting wavefunctions, topological insulator band states. It can also include wavefunctions which are superpositions and hybridizations of wavefunctions and entangled states. Electronic wavefunctions have energy levels that are measurable, for example, by tunneling, photoemission and electrochemical spectroscopies and electron densities that are measurable by scanning tunneling spectroscopy. Interaction between wavefunctions can be improved via factors such as wavefunction shapes, mutual proximity and quantum energy level alignment. As noted herein, it can be challenging to obtain a sufficient dielectric layer for quantum hybridization purposes (e.g., no resistance peaks identified). Additional steps may need to be taken for more vigorous cleaning approaches so that resistance peaks are identified.

The wavefunction “overlap” can be accurately characterized as wavefunctions “interact”. For example, there can be a change in an interaction energy between the first wavefunction and the second wavefunction, which induces a change in resistance of the first material. To eliminate “when”, in some embodiments, there is a feature, namely an actuator that modifies the quantum charge exchange interaction and modifies the first material's resistance. This actuator can be a voltage (shifts the first material and second material energy levels) or a concentration modifier (e.g., flow cell or an immersion cell in which concentration can change with time).

A number of variations of the dielectric layer or coating are also proposed, including variations where there is a complex dielectric constant, a varying thickness profile across the first material, varying composition with respect to distance to enable certain types of sensing, among others. The dielectric layer or coating can be practically implemented in the form of a layer of solvent and can also include a portion that is a vacuum.

Other variations of the above are also possible, including the specific use of graphene as the first material, as well as a stacked first material (graphene) and the second material (intercalated graphite). Intercalated graphite is useful in energy storage devices such as Li-ion batteries and as quantum materials such as superconductors. The WE can include a chromium adhesion layer, which can be advantageous to prevent various films (for example, gold and silver) from detaching from their substrates. The WE can also include self-assembled monolayer (SAM) which functionalizes the WE. A SAM consists of molecules that attaches to the WE via chemical bonding and have a molecular structure that can act as a dielectric spacing layer, and/or permits binding, and thus detection, of additional chemical species. For example, n-alkanethiol monolayers (with varying n(2<=n<=7)) can act as dielectric layers on gold films, and SAMs including a terminal carboxylic acid group can bind to metal ions.

Further variations can include discontinuous films, potentially near or further away from a percolation threshold. Additional variations can include mixtures of materials as well as layers of materials. Such combinations may be advantageous for applications related to developing, testing or monitoring catalytic activity, and sensing or detecting species of interest (e.g., via their redox activity at certain potentials, ability to degrade film response as monitored via a reduction in transient resistance peak features, and the like).

In practical application, variants of the proposed electrochemical cell can be used as a circuit module or a circuit component, and used in combination with other electronic devices and/or control devices to generate signals and measure resistance responses. These resistance responses can be measured against specific inputs and quantum transition state characteristics of the various materials can be tracked, for example, in the form of electronic data sets such as oscilloscope traces for downstream analysis (e.g., resistance peak detection as a function of varying voltage or current or gating electric fields). These electronic data sets can be used for artifact detection or point of interest extraction, providing a measurement instrument that can be used to measure various electrical properties. These electrical properties can include measurements of quantum phenomena, providing a novel mechanism for practically assessing material characteristics such as identifying an element, ion, compound, etc. As an example, such measurements can be performed along with CV measurements to provide enhanced assessment of material characteristics compared with CV measurements alone. These material characteristics can then be used for further practical applications, such as detecting chemical species including poisons for catalysts, monitoring catalysis activity, monitoring electrode degradation, estimating material failure, tracking the progress of a redox reaction, among others. Specific example approaches for device fabrication are described herein.

An embodiment of the apparatus can include (a) at least one gate electrode, (b) a drain probe, and (c) an electronic circuit including at least one processor that determines the resistance or change in resistance in the first material.

In this example, the at least one gate electrode (e.g., having a solid-state structure) is configured to receive at least one gate electrical signal and to generate at least one gate electric field that shifts the at least one first material quantum energy level relative to the at least one second material energy level, thereby modifying a hybridization between the first and second material wavefunctions or quantum states. A hybridization between the first and second material wavefunctions or quantum states can be defined as a mixing of wavefunctions or quantum states such that an electron can be thought of as being quantum mechanically associated with both wavefunctions or quantum states.

In one example, such mixing of quantum states or charge sharing can be viewed as interference. If the first material and the second materials are brought in a proximity of each other on a scale characterized by the Bohr length, the first and second material wavefunctions may constructively interfere, destructively interfere or some combination of the two depending on their relative phases. Since the wavefunctions oscillate in time at frequencies given by their respective energy divided by Planck's constant, in order to maintain the constructive interference, for example, the first and second energy levels should be similar. Otherwise, if the oscillation frequencies are significantly different, constructive interference can not be maintained over time. If constructive interference is maintained, there is a significant probability for a charge to be shared, resulting in a bond. The charge may be viewed as having both properties of both states. For example, if the first material has a delocalized, metallic band state and the second material has a localized atomic state, the materials are brought in a proximity of each other such that their respective wavefunctions can interfere constructively, the energy levels are similar (potentially with the aid of at least one gate electric field), then the states may hybridize, a charge can be shared, the charge exists in both the delocalized and localized states, the delocalized metallic band state acquires a localized character, and the impedance (incl. resistance, capacitance) of the first material can increase. Conductance, which is a component of impedance, may also be measured.

In another example, such mixing may be viewed as scattering process. If the first and second materials are brought in a proximity of each other, but their energy levels are too far apart, a charge in the delocalized metallic state can not scatter off the localized state. Energy levels have widths given by lifetimes and the uncertainty principle: the shorted the lifetime, the broader the energy level width. As energy levels more closely align (potentially with the aid of a gate electric field) and the energy levels overlap given their widths, the states can hybridize and a charge in the delocalized metallic state can exist in the localized state for a period of time with the aid of the uncertainty principle; i.e., scattering can occur. As a result, the charge can be thought of existing in both delocalized and localized states, and the impedance (incl. resistance, capacitance) of the first material can increase. Conductance, which is a component of impedance, may also be measured.

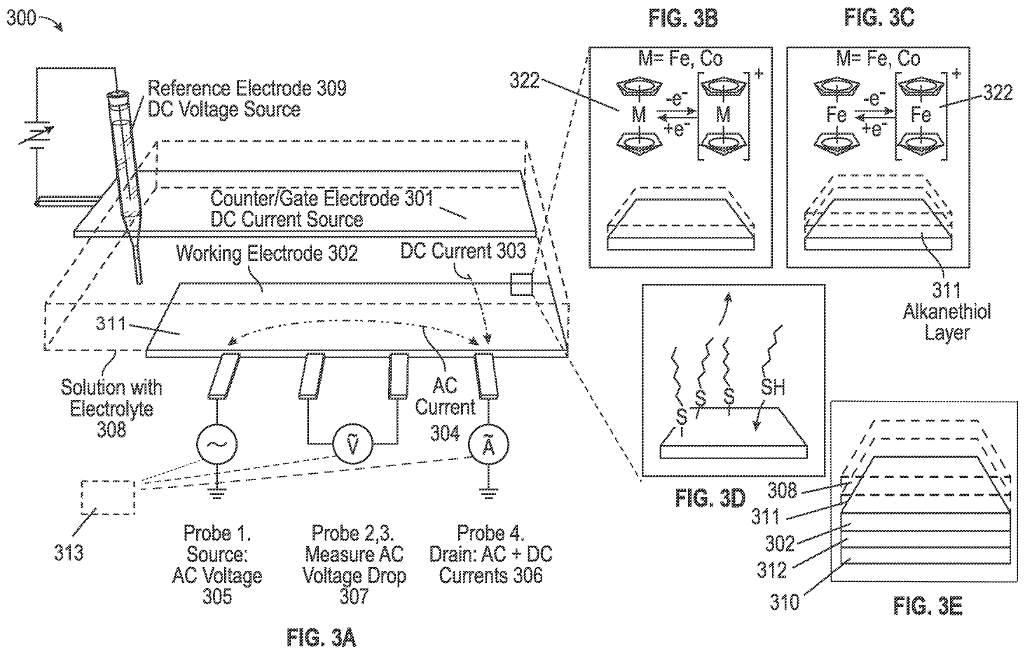

In an embodiment, a dielectric layer 311 (shown in FIG. 3A) of apparatus 300 may help enable this hybridization as the dielectric coating functions by enabling and potentially controlling the mixing through, for example, dielectric layer thickness. For example, if a dielectric layer is an ordered self-assembled monolayer whose thickness is, for example, on the Bohr length scale, wavefunction hybridization systematically improves as self-assembled monolayer thickness decreases. In the limit that self-assembled monolayer thickness is zero, vacuum or solvent or solution can serve as the dielectric layer. However, if the surface has contamination that is significantly thicker than a characteristic length of the first and second material wavefunctions, hybridization will be poor.

A number of different variations of dielectric layers are proposed in different variants, such as a self-assembled monolayer, having a portion that is a vacuum, or a di-electric coating having a complex dielectric constant. Examples can include semiconducting materials (for example, conjugated molecules) that have an ability to both polarize and conduct charges in response to an electric field. The dielectric layer can have a varying thickness profile. The dielectric layer can also vary in composition relative to a distance from a surface of the first material, and can also include solvent or electrolyte molecules.

The drain probe is configured for electrical contact with the first material and configured to measure a response of the first material to the gate and source electrical signals, at least one of the gate and source electrical signals having an alternating current (AC) component.

The one or more processors of the electronic circuit are configured to determine a resistance or a change in resistance the first material upon measuring the response of the first material while the first material participates in one or more electrochemical reactions, the resistance or the change in resistance of the electrode established at least partially based upon the hybridization.

The apparatus 300 can be used for practical applications, such as detecting chemical species including poisons for catalysts, detecting metals that catalyze production of reactive oxygen species which can degrade membranes in electrolysers, fuel cells and batteries, detecting reactive oxygen species themselves, monitoring catalysis activity, and monitoring electrode degradation.

For example, when using the apparatus as a sensor for chemical species that poison catalysts, an approach can include using a thin catalyst film as the WE and monitoring the size of the resistance peak. As a poison binds to the working electrode of the sensor, the resistance peak can diminish. This information can be used to sense a catalyst poison and upon such sensing take measures to protect catalysts downstream.

Measures can include providing a signal that can trigger an alarm, shut down a process, and the like. Similarly, for monitoring catalysis activity or electrode degradation, an approach can include monitoring resistance peaks generated by elements of an array of catalysts or electrodes.

Upon reduced performance of an element, which may be correlated with degradation of a resistance peak generated by the degraded element, a corresponding signal may be provided and corrective measures may be taken, such as regenerating or replacing the degraded element.

This approach provides multiple benefits, such as reducing cost (for example, by replacing just the degraded element rather than the whole array) and enabling improved performance (for example, by monitoring performance of the array element-by-element rather than that of the whole array).

This approach may be beneficial, for example, in fuel cells which comprise an array of electrodes each with catalyst coatings. The proposed approaches provide additional benefits as tracking the resistance or the change in resistance allows further accuracy or granularity in conducting practical measurements.

An approach relating to thin film resistance gating by charge exchange is also described herein. One limitation of using solid-state dielectric material (e.g., silicon oxide) in FET configurations is that its area capacitance is relatively low. As an example, 300 nm SiO₂ can insulate˜±100 V gate voltage, but with area capacitance of only 0.01 μF cm⁻², the maximum surface charge carrier doping concentration is only on the order of 10¹³ cm⁻². For context, a material surface with a lattice constant of 5 Å has ˜4×10¹⁴ atoms/cm² (assuming square lattice). One popular method of gating that achieves higher surface charge carrier doping concentration is electrolyte gating.

An electrolyte consists of mobile ions that can accumulate near a material surface depending on the charge of the material. Ions of opposing charge will be attracted to the material in an attempt to shield the electric field of the excess charge, forming an electric double layer (EDL). The thickness of the EDL is typically on the order of nm. As a result, using an electrolyte as a field gate dielectric causes even a small potential difference of several volts across the EDL to generate very strong electric fields(˜10⁹ V/m). This fact enables electrolyte gating as a means of achieving surface charge carrier doping concentration beyond 10¹⁴ cm⁻². Many reports employ EDL gating to modulate the conductance of materials. For example, in the publication Hidekazu Shimotani, Haruhiko Asanuma, Atsushi Tsukazaki, Akira Ohtomo, Masashi Kawasaki, Yoshihiro Iwasa; Insulator-to-metal transition in ZnO by electric double layer gating. Appl. Phys. Lett. 20 Aug. 2007; 91 (8): 082106. https://doi.org/10.1063/1.2772781, the contents of which are hereby incorporated by reference, the authors employ this approach to increase the carrier concentration in ZnO single-crystalline thin film transistors to 4.2×10¹³ cm⁻² and drive an insulator-to-metal transition. A special type of electrolyte ideal for gating experiments is ionic liquid (IL). Ionic liquids are compounds consisting entirely of ions as opposed to ions dissolved in a solvent. They are liquid-state salts at room temperature. ILs have intrinsic ionic conductivity and a wide electrochemical window. Moreover, ILs can be used as solvents for (reduction and oxidation) redox-active species and freeze to a glassy state at cryogenic temperatures. For example, in the publication Rajiv Misra, Mitchell McCarthy, Arthur F. Hebard; Electric field gating with ionic liquids. Appl. Phys. Lett. 29 Jan. 2007; 90 (5): 052905. https://doi.org/10.1063/1.2437663, the contents of which are hereby incorporated by reference, the authors employ an IL as a field gate dielectric to change the carrier concentration of InOₓ thin films and drive an insulator-to-metal transition.

Another class of devices relevant to this specification is the Electrochemical Transistor (ECT). ECT devices, like FETs, consist of a gate electrode and electrolyte. The source-drain material may be an organic film or an inorganic film. When a voltage is applied to the gate electrode, ions are injected into the film, causing the doping (redox) state of the film to change which alters the film conductance. Much like electrostatic and electrolyte gating techniques, the charge carrier concentration is modified to achieve conductance modulation. Devices described in U.S. Pat. No. 10,429,343B1, the contents of which are hereby incorporated by reference, employ such a gating technique to migrate ions in or out of the film, changing the oxidation/reduction level and conductance of the film.

Although the three gating methods discussed above can have different device geometry and implementation, the methods modulate material conductance by the same classical mechanism—changing charge carrier concentration. While all three gating methods described above exploit surface effects (e.g. thin oxide dielectric in the case of electrostatic gating, and EDL in electrolyte and electrochemical gating), the present disclosure has identified the possibility that a similar device configuration can also probe surface charge sharing/exchange processes which are fundamentally quantum mechanical in nature.

In this specification, the two current experimental techniques enabling the measurement of thin film resistance and electrochemical reactions are described by way of introduction, namely 4-probe resistance measurement and cyclic voltammetry (CV).

Furthermore, it is described how an innovative combination of these techniques, which Applicants refer to as a “charge exchange transistor (CET)”, can probe molecule-band hybridized quantum states. This disclosure also describes approaches probing the metallocene molecule-Au band hybridized states using the CET. A multitude of experimental and computational evidence supporting the proposed mechanism of a redox transition state is provided.

A series of control experiments are also presented to rule out alternate explanations of the results observed.

When measuring resistance, the first instrument that comes to mind is the hand-held digital multimeter. It has two probes that make electrical contact with a sample of interest. A small current is sent between the electrodes through the sample and the voltage drop across the sample is measured.

The resistance can then be determined by Ohm's law as the voltage drop divided by the current. This method is known as a 2-probe (terminal) resistance measurement. A major drawback hides behind the method's simplicity. Suppose one wishes to measure the resistance of an electrically conductive metal, the contact between the metal and the multimeter probe will add additional contact resistance making the measurement inaccurate. The standard technique to eliminate the effect of contact resistance is the 4-probe (terminal) technique.

The 4-probe technique can compensate for contact resistance by separating the current leads from the voltage leads. In the simplest case, 4 electrodes make contact with the sample arranged in a line. Applicants will call the 4 electrodes E1 to E4 respectively. A technician can measure the current that enters the sample at E1 and exist at E4 with an ammeter (or equivalent circuits). Meanwhile, one can simultaneously measure the voltage drop across E2 and E3 with a voltmeter (or equivalent circuits). Because a voltmeter has a very high input impedance compared to the resistance of the sample, negligible current will flow in/out of the sample through E2 and E3. This ensures that no voltage is dropped at E2 and E3 even in the presence of significant contact resistances. According to Ohm's law, if the current is zero, the voltage drop is zero regardless of the contact resistance. Now if one divides the voltage drop across E2 and E3 (V₂₃) by the current across E1 and E4 (I₁₄), one can calculate the resistance of the portion of the sample between E2 and E3. Although it is always desirable to minimize contact resistance, it is not always possible. The contact resistance may vary depending on the method used to make the electrical connection (e.g., soldering, conductive epoxy, metal film evaporation/sputtering).

One technique that is commonly used to extract weak periodic signals from a noisy background is lock-in amplification. A lock-in amplifier consists of 3 connections: an input, an output and a reference. A reference periodic signal is fed into the lock-in amplifier and is multiplied by the input signal using a frequency mixer. The resultant signal has frequency components equal to the sum and difference of the frequencies of the reference and input signal. If the reference and input signals are sine waves that have the same frequency f, this step results in a signal with a DC component and an AC component with frequency 2f.

A low-pass filter can be applied to leave only the DC component which can be measured at the output by an analog-to-digital converter (ADC). The use of lock-in amplifiers in 4-probe resistance measurement is desired when high signal-to-noise ratios are required. Instead of a DC current (I₁₄), one can use an AC current source instead. This can be achieved by pairing an accurate AC voltage source (e.g., a function generator) to a current amplifier (for impedance matching) to drive periodic current through E1 and across the sample. We can convert the current signal at E4 into a voltage signal using an op-amp transimpedance amplifier (current-to-voltage converter) with a set gain and a lock-in amplifier. The AC current will induce an AC voltage drop across E2 and E3 which can be measured by another lock-in amplifier. The ratio of AC voltage to AC current is the sample resistance.

### Cyclic Voltammetry (CV)

Cyclic voltammetry (CV) is a technique that quantifies reduction and oxidation (redox) electrochemical processes. In inorganic chemistry, the redox-active species is often a metal complex. CV is a technique that varies the electrical potential of a molecule relative to that of an electrode such that the Fermi energy level of the electrode is brought into alignment with the highest occupied molecular orbital (HOMO) energy level or lowest unoccupied molecular orbital (LUMO) energy level of the redox-active species.

When this occurs, charges can be transferred between the electrode and molecule thereby completing a redox reaction. In a CV measurement, one places electrodes in a solution containing the species of interest and varies the electrode potential cyclically. The current through the electrode can be measured to determine the reaction rate. When redox current is plotted against voltage, this is called a cyclic voltammogram.

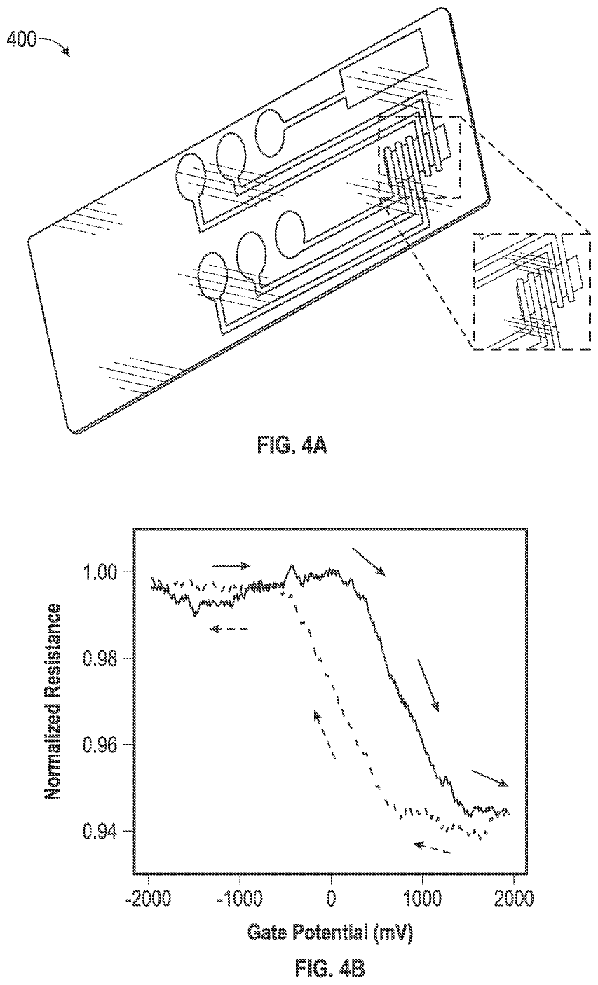

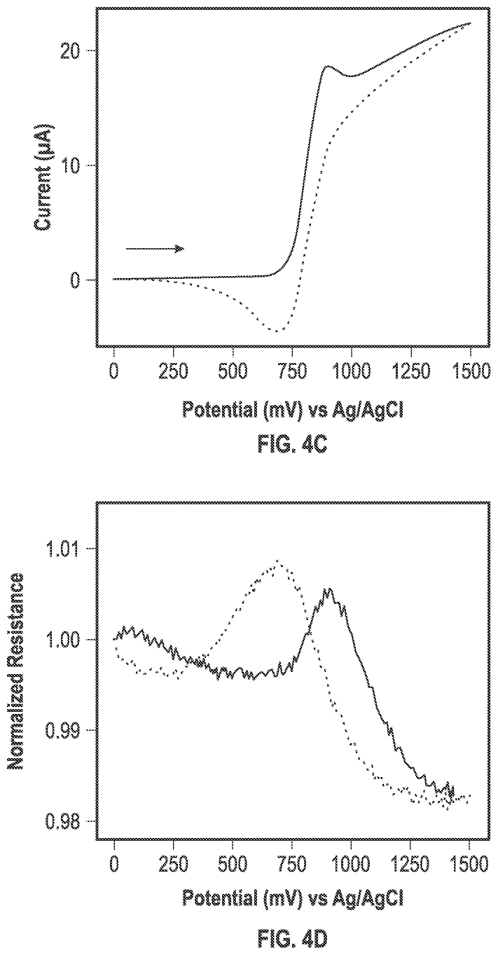

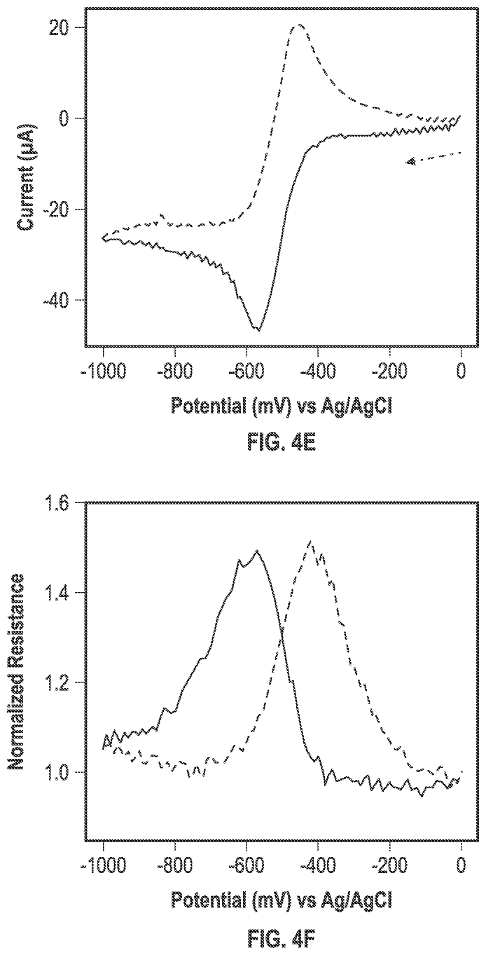

A typical cyclic voltammogram is shown in FIG. 4E.

In the lower curve, the potential is decreased and oxidation reactions occur. When the Fermi energy level of the electrode is aligned with HOMO energy level of the redox-active species, in this case ferrocene (Fc), the redox-active species loses an electron to the electrode causing a (negative) current peak. Past the oxidation potential, the current (number of reactions per unit time) drops because the unoxidized Fc molecules in the electric double layer (EDL) are depleted and the reaction rate is limited by diffusion from the bulk solution. In the reverse potential sweep (upper curve), the Fermi level of the electrode is brought into alignment with the LUMO energy level of oxidized Fc⁺ molecules and electrons flow from the electrode back to the Fc⁺ molecules and reduce it back to Fc which completes the cycle, producing a (positive) current peak. This gives the typical “duck” shaped curve of cyclic voltammogram.

In practice, CV may be performed with at least 3 electrodes. The electrode where the redox reactions take place is the WE It is typically made out of an inert material that has a well-defined surface area (e.g., glassy carbon or Au disk). Another counter electrode (CE) is required to complete the circuit. The role of the CE is to enable the desired potential across the solution-WE interface and to ensure that enough current can be supplied for the reaction. Typically CEs are made from an inert material with a large surface area (e.g., Pt mesh). The final electrode required is the reference electrode (RE) 309 shown in FIG. 3A. It acts as the potential standard of the reaction. The RE should be placed close to the WE to reduce undesireable potential drops as much as possible. When the CE applies a voltage, it is referenced against the RE. This will ensure the potential across the solution-WE interface is at the level defined by the user and that any resistive voltage drop across the solution-electrode interface and within the solution is compensated for. The device that controls the potentials of the 3 electrodes is called a potentiostat.

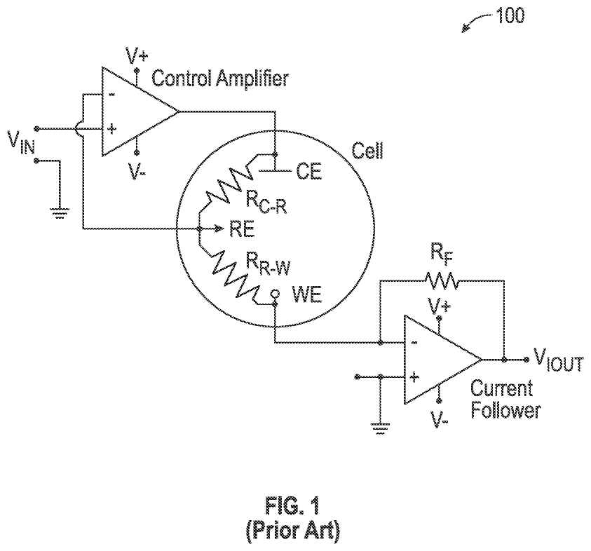

The circuit diagram of simple potentiostat 100 is shown in FIG. 1.

FIG. 1 is an example schematic diagram showing a simple potentiostat 100 using op-amps. FIG. 1 is prior art.

In the op-amp implementation of a potentiostat (e.g., FIG. 1), one op-amp is used to control the RE potential. A variable voltage source is connected to the non-inverting input of the control op-amp. The input voltage can be controlled by the user via a digital-to-analog converter (DAC). The RE connects to the inverting input of the op-amp forming a feedback loop. The RE is a voltage standard that utilizes the known potential of a reaction. For instance, a RE can be made from Ag wire in aqueous KCl. This is called a Ag/AgCl RE and it uses the known potential of the Ag/AgCl reaction.

The potential at the inverting input of the control op-amp is the sum of the solution potential and the RE potential (a constant offset). If the input voltage differs from the solution potential+RE potential, the op-amp will amplify the difference and adjust the op-amp output (connected to the CE) voltage to compensate. On the WE side, a current follower (current-to-voltage converter) is used.

Since the non-inverting input of the current follower op-amp is tied to ground potential, the inverting input of the op-amp acts as a virtual grounding point. It will sink/source current through the op-amp output and gain a resistor according to the reaction rate at the WE.

The redox current flows through the resistor labelled (R_{F}) and the voltage drop is measured by an ADC at the op-amp output. The purpose of the potentiostat is to ensure the potential across the solution-WE interface is that of the user input. As a result, by shifting the user input voltage (cyclically in the case of a CV), one can drive redox reactions at the WE and measure the redox current with respect to potential relative to a RE potential.

### Charge Exchange Transistor Configuration

As described herein, it is proposed by Applicants to combine a CV-capable potentiostat and a 4-probe resistance measurement apparatus to arrive at a charge exchange measurement apparatus. In this specification, Applicants refer to an embodiment of the approach as the charge exchange transistor (CET) apparatus, but it does not necessarily always need to be a transistor. For example, the proposed approach can also be described as an extension of an electrochemical cell.

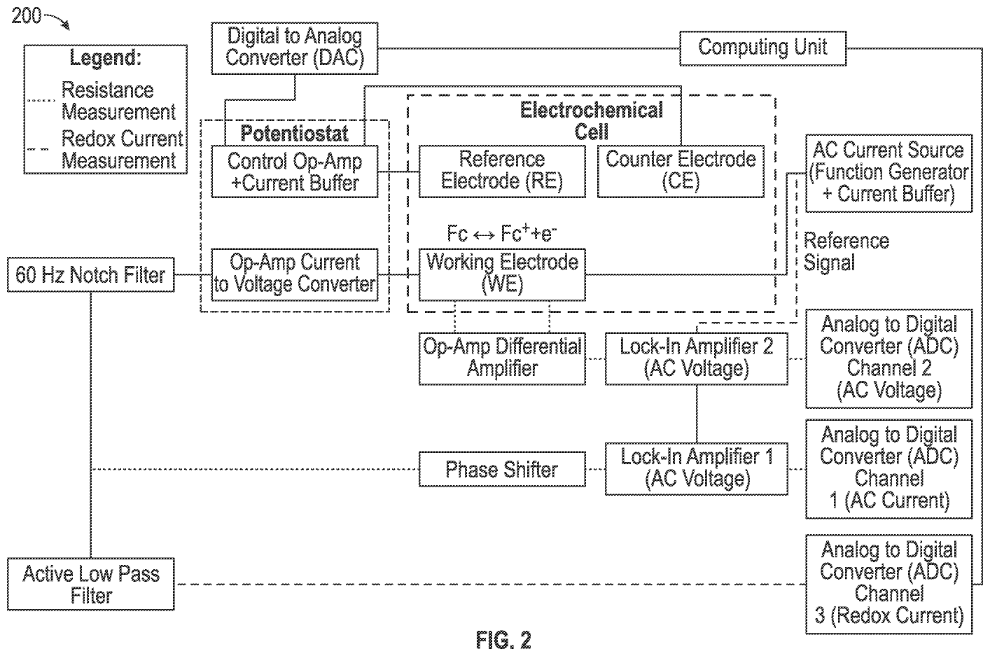

The CET apparatus is capable of measuring the resistance of the WE while a CV measurement is performed. It enables the user to measure the EDL gating effect of the electrolyte and explore the effect of redox charge transfer on the WE resistance the result of which led to the hypothesis of the existence of a quantum transition state described further in this specification. The functional block diagram of the CET apparatus 200 is shown in FIG. 2.

For the potentiostat, a computing unit running a LabVIEW program controls a DAC and applies the control voltage to a control op-amp. It is connected to the RE and CE as in the configuration described by FIG. 1. A current buffer is provided between the output of the control op-amp and the CE to provide sufficient current. A current-to-voltage converter op-amp measures the current from the WE and converts it to a voltage signal which is then filtered by a 60 Hz notch filter in order to eliminate powerline noise. The filtered signal is further filtered by an active low pass filter to eliminate any AC component leaving only slowly varying quasi-DC redox current unattenuated. This analog signal is converted to a digital signal by an ADC connected to the computing unit.

For the 4-probe resistance measurement, a function generator generates a 300 Hz sine wave voltage. A current buffer is used to ensure sufficient current can be supplied. The sinusoidal current, provided to the E1 electrode of the WE (as discussed above; also see FIGS. 3A-E), flows across the WE, combines with the redox current and flows into the current-to-voltage converter op-amp through the E4 electrode of the WE. Again, 60 Hz powerline noise is removed, but instead of further filtering by a low pass filter, the resultant signal is conditioned by a phase shifter and a lock-in amplifier.

The phase shifter compensates for the phase delay of the notch filter. This is salient because the lock-in amplifier is sensitive to the relative phase of the input vs. reference signal. A phase mismatch will cause errors in the current measurement. In other embodiments both the in-phase and out-of-phase components of the current (or equivalently the amplitude and phase shift) may be recorded to provide the impedance of the working electrode. In other embodiments, the impedance may be measured at different frequencies. Impedance measurements can provide information about both resistance and capacitance of the WE. This can be useful as capacitance of the WE in an electrolyte may be sensitive to changes in surface area of the WE and may enable monitoring of deposition of material on the electrode. The current signal is finally digitized by another channel of the ADC. Furthermore, two voltage probes (electrodes E2 and E3) are connected to the WE and their AC voltage drop is measured by an op-amp differential amplifier and another lock-in amplifier. The voltage is digitized by a third channel of the ADC. FIG. 2 is a block diagram showing an example CET apparatus, according to some embodiments.

### Gating Thin Film Resistance by Redox Charge Exchange

Field effect gating is an effective means for changing carrier charge density, shifting energy levels and thereby modifying electronic conductivity. The most common field-effect transistor (FET) configuration employs three electrodes. Charge flows via source-drain electrodes through a material depending on its resistance. Simultaneously, the material, a dielectric insulator spacer and a third (gate) electrode form a capacitor. A voltage applied to the gate electrode creates an electric field across the dielectric insulator spacer, charges/discharges the material, classically modifying its charge carrier density and, therefore, the source-drain resistance. Optionally, additional electrodes can be connected to the material; for example, a 4-probe configuration enables measurement of the material resistance without contributions from material-electrode contact resistance. Reports in the literature study the effects of strong gating employ ionic liquids (ILs) as the dielectric between the gate electrode and a material of interest.

ILs can screen the electric field created by the gate voltage except within a very thin electric double layer (EDL) near the material surface, resulting in a large capacitance and a correspondingly large change in material carrier charge density per unit gate voltage. IL gating has enabled observation of insulator-to-metal transitions in InOₓ and ZnO thin films, field-induced superconductivity in SrTiO₃, and ferromagnetism and the Kondo effect in Pt.

Interestingly, the conductance of thin gold films can be modulated significantly by IL gating despite the inherently high density of charge carriers typically found in metals. Gating experiments using an electrolyte solution as the dielectric can achieve ˜1% conductance modulation, while gating using IL can achieve 3-5% modulation at room temperature and up to 10% modulation at low temperature. Recent studies using electrochemical impedance spectroscopy (EIS) and x-ray absorption near edge structure (XANES) suggest that reversible redox generated by IL gating, i.e. changes in the chemical composition of the gold surface, combined with changes in free electron density explain the large conductance modulations observed.

While FETs are enormously useful, they are classically actuated as they employ an electric field to change the electrical conductivity of a material. Previous studies have shown that quantum hybridization of localized atomic d or f states with delocalized band states of a material can lower electrical conductivity of the material as the initially delocalized band states adopt a localized atomic character (Kondo effect).

Quantum hybridization has potential transistor applications as a means to actuate gating by way of charge sharing, leading to a possibility of quantum charge exchange transistors (CETs). In turn, CETs may be useful for probing such interactions. Here, this disclosure demonstrate a feasibility of CETs by integrating FET and electrochemical cell configurations to enable charge exchange or sharing (gating) between a thin film and redox molecules (ferrocene, Fc, and cobaltocene, Cc), while simultaneously monitoring thin film (source-drain) resistance for possible modulation or gating effects—see FIGS. 3A-3E and discussion below.

In one embodiment, Applicants use a thin Au film as the gated material/WE, and 4-probes to monitor film resistance, and observe two distinct types of resistance changes during cyclic voltammetry (CV).

One is consistent with classical capacitive gating caused by field-effect charging. Remarkably, another is a large (˜10% to ˜100%) transient resistance peak that occurs during both oxidation and reduction that is associated with redox current itself.

After performing a series of control measurements, Applicants hypothesize that the transient resistance peaks are associated with a metallocene/metallocene⁺-Au film transition state. The predictions using a kinetics model derived from this hypothesis are tested, namely the effect of varying Fc concentration and the relationship between transient resistance increase vs. redox current, and find that the model's predictions are consistent with observed trends.

Using self-assembled n-alkanethiol (CH₃(CH₂)ₙ₋₁SH) monolayers on Au as spacers with thicknesses that are tunable via n(2≤n≤7), Applicants investigate the dependencies of redox current and transient resistance peaks on Fc/Fc⁺-to-Au film distance. Significantly, both transient resistance and redox current peak heights drop exponentially with Fc/Fc⁺-Au distance, with the decay for resistance peaks being 30% more rapid than that for redox current peaks. Accordingly, given the atomic length scales involved, Applicants propose that the transition state arises from quantum hybridized molecule-Au band states (qHMB) that localize charge carriers between Fc/Fc⁺ and the film and thus quantum mechanically actuate the increase in Au film resistance (CET).

These results are consistent with density functional theory (DFT) calculations modelling electron density evolution both as charge exchange proceeds and as Fc/Fc⁺-to-Au film distance varies. As a further demonstration, Applicants self-assemble a monolayer of n-alkanethiol on a Au film, thereby oxidizing the top layer of Au and forming thiolate, and observe that the film's resistance increases with time.

The resistance increase qualitatively follows fast-then-slow self-assembly kinetic steps that have been previously observed using other approaches. These results are significant as they reveal a potential multi-step mechanism for redox involving the formation/destruction of a transition state, provide a more complete basis for the quantum mechanical nature of charge exchange processes, and point to the application of CET as a means to explore other charge exchange processes.

FIG. 3A, FIG. 3B, FIG. 3C, FIG. 3D, FIG. 3E together are a schematic diagram and different expanded views of an example charge exchange transistor, according to some examples.

FIG. 3A shows a schematic of the CET 300. In a standard electrochemical cell, a voltage is applied to a counter electrode (CE) 301 relative to a WE 302, driving current between the CE and WE and enabling charge exchange between redox-active species, e.g. in liquid 308 optionally a solution with electrolyte and/or an ionic liquid, and the WE. DC Current 303 and AC current 304 are illustrated in FIG. 3A.

FIG. 3A shows a charge exchange transistor 300 combining a 3-electrode electrochemical cell with a 4-probe configuration to measure WE resistance during CV. Various means can be employed to generate charge exchange with the WE.

For example, FIG. 3B shows an illustration of redox of metallocene in solution. FIG. 3C shows an illustration of redox of Fc in solution using Au WE coated with self-assembled n-alkanethiol (CH₃(CH₂)ₙ₋₁SH) monolayers with varying thicknesses (2≤n≤7). FIG. 3D shows an illustration of a real-time n-alkanethiol self-assembly on the charge exchange transistor Au WE.

The current as a function of the voltage of the RE relative to the WE is measured. Here, thermally deposited Au films on glass substrates with a Cr adhesion layer serve as CE (25 nm Cr+100 nm Au) and WE (8 nm Cr+10 to 50 nm Au), respectively. Standard aqueous Ag/AgCl serves as the RE.

Applicants use an operational amplifier to apply a voltage to the RE relative to ground and drive current between the CE and WE. Note that since in a standard electrochemical cell, a voltage is applied using the RE as a reference, applying a voltage to the RE results in a relative sign change. As in conventional CV, Applicants vary the applied voltage, and current flows between CE+RE and WE.

To measure WE resistance changes induced during CV, the WE has 4 electrodes/probes in the illustrated configuration. In addition, here Probe 1 (source electrode 305) applies a small, sinusoidal AC voltage to the WE, and Probe 4 (drain electrode 306), which is referenced to ground, measures the currents generated by both CE+RE and the sinusoidal voltages. CV current generated by the CE+RE varies slowly and is measured by time-averaging and low-pass filtering, while sinusoidal current generated by Probe 1 is measured using a lock-in amplifier. High input impedance buffers are used to avoid drawing current from Probes 2 and 3, together element 307, and therefore dropping any voltage across contact resistances. A second lock-in amplifier simultaneously accurately measures the AC voltage drop across the Au film between Probes 2 and 3.

The resistance of the WE during CV is determined using the sinusoidal current and the corresponding AC voltage drop across probes 2 and 3. Using this CET configuration, 3 charge exchange processes involving the WE (see FIGS. 3B-3D) can be studied: redox of metallocene (ferrocene, Fc, and cobaltocene, Cc) in solution using a bare Au film WE; redox of Fc in solution using a Au film WE with self-assembled n-alkanethiol monolayers where Applicants vary n; and real-time self-assembly of n-alkanethiol on a Au film WE.

The CET apparatus enables the user to quantify the transient resistance changes of the WE during a redox reaction and it offers a probe into the charge transfer process which involves the hybridization of molecular states and metallic band states as respective energy levels shift relative to each other. Results measured from the CET are presented further in this specification.

In an embodiment, apparatus 300 shown in FIG. 3A may monitor an impedance or a change in the impedance of first material 302 (i.e. the working electrode) which has a first material quantum state with a first material electron density distribution and at least one first material quantum energy level. Apparatus 300 may be configured to receive in proximity with the first material a second material 322 having a second material quantum state with a second material electron density distribution and at least one second material quantum energy level. First material 302 may be selected to have a first material quantum energy level for forming a hybridized quantum state with second material 322. As shown in FIG. 3A, apparatus 300 may comprises: a source probe 305 configured for electrical contact with the first material 302 and configured to apply a source electrical signal to the first material 302. At least one gate electrode 301 (also referred to as a counter electrode) may be provided to receive at least one gate electrical signal and to generate at least one gate electric field that shifts the at least one first material quantum energy level relative to the at least one second material quantum energy level, thereby modifying a hybridization between the first and second material quantum states and the first and second material electron density distributions. A drain probe 306 may be configured for electrical contact with first material 302 and configured to measure a response of the first material 302 to the gate and source electrical signals. At least one of the gate and source electrical signals may have an alternating current (AC) component. One or more processors 313 may be configured to: receive data comprising the response from the drain probe 306, determine the impedance or the change in the impedance of the first material 302 upon measuring the response of the first material 302 while the first material 302 participates in one or more electrochemical reactions, the impedance or the change in impedance of the first material electrode 302 established at least partially based upon the hybridization between the first and second material quantum states. Processor 313 may then determine a material characteristic of the second material 322 based on at least one of the impedance or the change in the impedance of the first material.

FIGS. 4A-4F are a set of diagrams depicting charge Exchange Transistor Characterization, Ionic Liquid Gating and Metallocene CV. FIG. 4A is an optical image of charge exchange transistor 400. Scale bar length: 2 mm.

FIG. 4B is a graph showing CV for an ionic liquid gating of an Au film. FIG. 4C shows CV of Cc in solution. FIG. 4D shows simultaneously measured normalized WE resistance during CV. FIG. 4E shows CV of Fc in solution. FIG. 4F shows simultaneously measured normalized WE resistance during CV. Arrows indicate potential direction.

FIG. 4A shows optical images of the device (main panel) and the thin, semi-transparent WE (inset). Five probes contact the WE, but only four are used during a given measurement. FIG. 4B-4F. show data from a series of control measurements used to test various embodiments of proposed CETs.

FIG. 4B shows normalized WE resistance vs. gate voltage using a common IL, DEME-TFSI, to bridge the CE and WE. Applicants vary the potential of the CE relative to ground potential to gate the WE, without a RE as in a standard FET configuration. These measurements are performed under Ar atmosphere to reduce the possibility of Au oxidation/reduction and to prevent the IL from degrading in air.

As gate voltage becomes sufficiently negative, negative ions accumulate in the IL near the surface of the WE film in an EDL. As a result, positive charges are induced in the film; i.e, free electron charge density decreases. Since resistance is inversely proportional to carrier density, resistance (R) is expected to increase as observed. The magnitude of ΔR/R due to a pure field effect is expected to be symmetric with respect to the sign of voltage at large voltage. However, film resistance vs. CE (gate) voltage exhibits some hysteresis and asymmetry, which is typically observed in IL gating. Applicants observe ΔR/R of +/−3%, which is of the same order as previously reported in the literature.

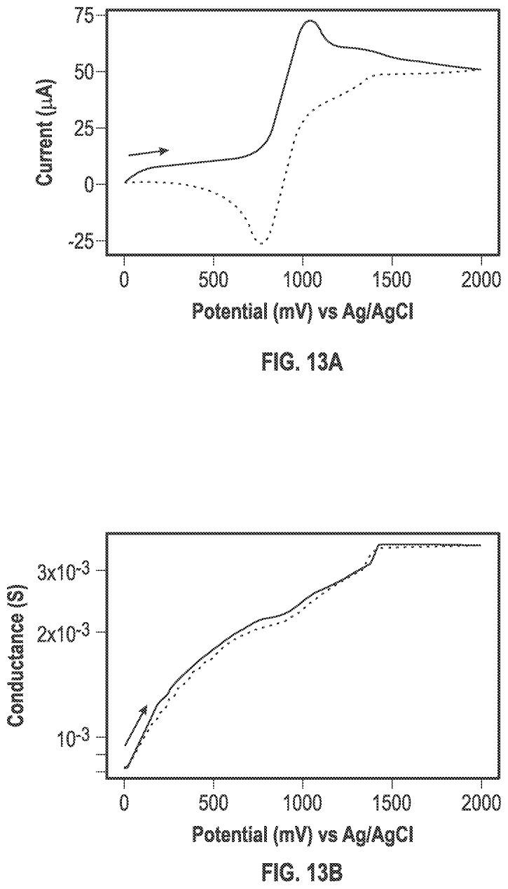

FIGS. 4D and 4F show resistance data measured simultaneously with CV data shown in FIGS. 4C and 4E, respectively. The resistance data exhibit peaks that occur at corresponding redox voltages as well as plateaus that flank the peaks. The resistance plateaus are attributed to double layer gating as described above. FIGS. 4C-4F exclude Joule heating of the Au film as an important contributor to resistance peaks. Joule heating is expected to increase with current; however, in FIG. 4C, for example, the total current at 1.5 V is a maximum over the range, yet the resistance is at a minimum and well below the peak. Currents are small overall in the present experiment(<100 μA), and the thin Au film is in good thermal contact with the substrate and the solution. To gain insight into the cause of the resistance peaks, Applicants perform a series of control measurements and find that the measured film resistance is unaffected when the film is maintained at 0 V and is immersed in solvent, electrolyte solution or electrolyte+Fc solution (see Appendix, FIGS. 13A-13C). That is, film resistance is sufficiently low that these liquids provide negligible parallel current pathways, including in a presence of Fc.

Also, performing CV using an electrolyte solution in the absence of Fc, Applicants find film resistance exhibits plateaus but no peaks. Since both the redox species and the film as well as charge exchange all play critical roles in generating the transient resistance peaks, Applicants hypothesize the existence of an intermediate Fc/Fc⁺-film charge exchange transition state.

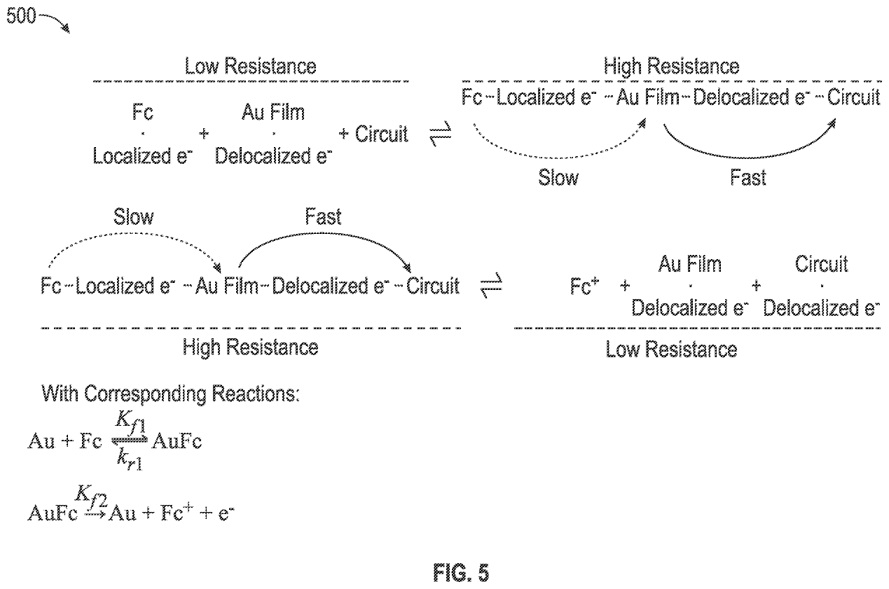

FIG. 5 shows a simple example of a potential charge transfer mechanism 500 involving such a state. For simplicity, Applicants neglect capacitive gating and focus on Fc oxidation. Initially, at zero potential, Fc is in its reduced state, the Au film possesses delocalized electrons, and film resistance is low. As the potential decreases to shift gold Fermi energy level and Fc HOMO energy level and drive Fc oxidation, an electron transfers from an initially localized state in Fc to the Fc/Fc⁺-film transition state. To maintain charge neutrality, the Au film must transfer a corresponding portion of a delocalized electron to the circuit. Fc/Fc⁺-Au film charge transfer is expected to be slower than that for Au film-circuit. This picture suggests that the higher resistance observed during Fc-Au charge transfer arises because an electron is shared within Fc/Fc⁺-Au film, and the Au film is depleted of a corresponding amount of charge. Finally, as Fc oxidation completes, the Au film gains an electron from the Fc, completes transferring an electron to the circuit, and restores its complement of free electrons, causing the film resistance to recover its original value before oxidation. Such localization of charge within the Fc/Fc⁺-Au complex during charge transfer qualitatively predicts a resistance peak during both oxidation and reduction waves, as observed.

More quantitative predictions can be obtained by noting a parallel between the redox mechanism proposed here involving a Fc/Fc⁺-Au film transition state and a two-step enzyme catalysis mechanism involving an enzyme-substrate complex. Applying a Michaelis-Menten kinetics enzyme kinetics model to the reactions in the proposed mechanism and assuming the transition state concentration rapidly reaches equilibrium, the model predicts:

$$Δ R ∝ {[ Fc / {Fc}^{+} - film ]}_{eq} = \frac{[ Au ] [ Fc ]}{\frac{{K}_{r 1}}{{K}_{f 1}} + [ Fc ]} ∝ [ Fc ] \qquad ( 1 )$$

Film resistance increases with [Fc/Fc⁺-film] _{eq} and in turn should increase linearly with [Fc] at low Fc concentration. Using the rate law for the second reaction, the rate of electron production is:

$$I ∝ {[ Fc / {Fc}^{+} - film ]}_{eq} ∝ Δ R , \qquad ( 2 )$$

where I is current. Film resistance also should increase linearly with the rate of product formation (ie. current), as again both R and I increase linearly with transition state concentration.

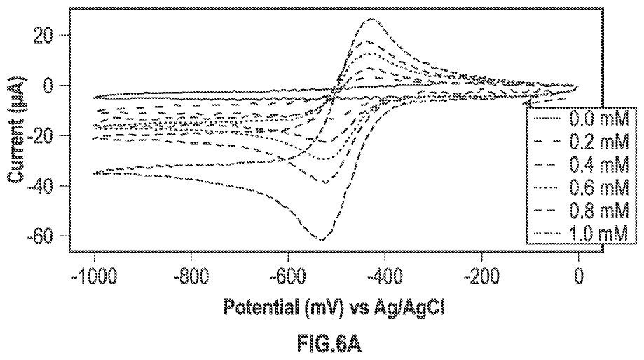

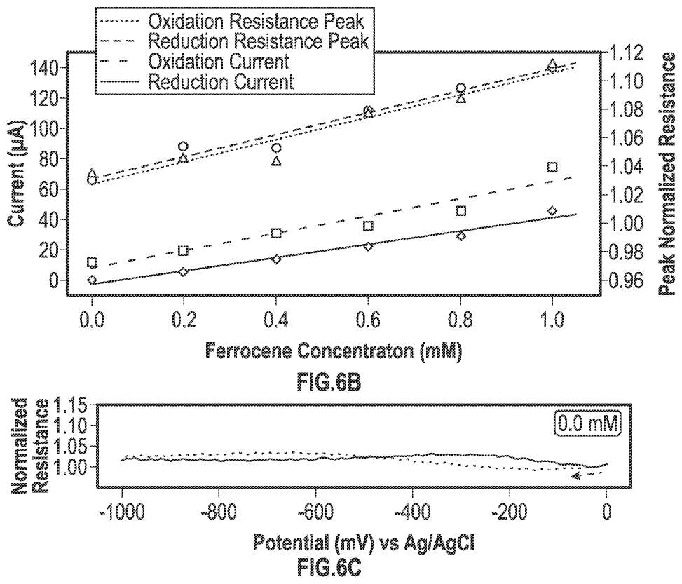

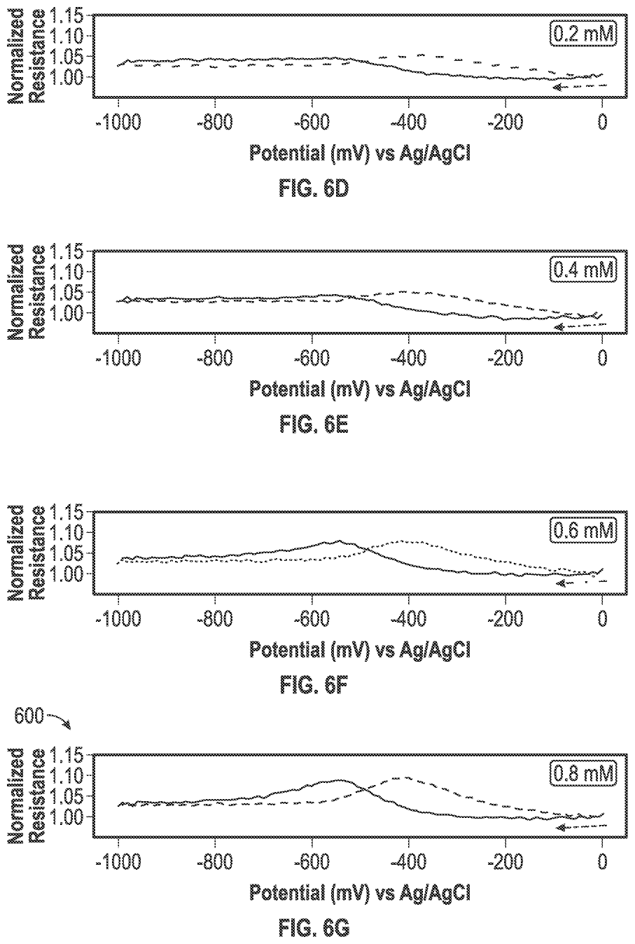

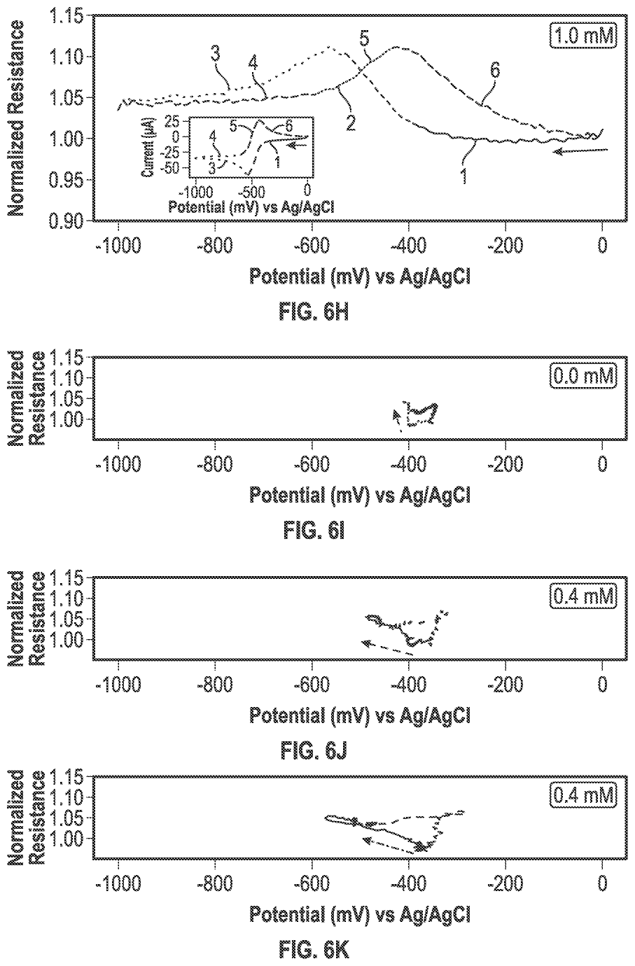

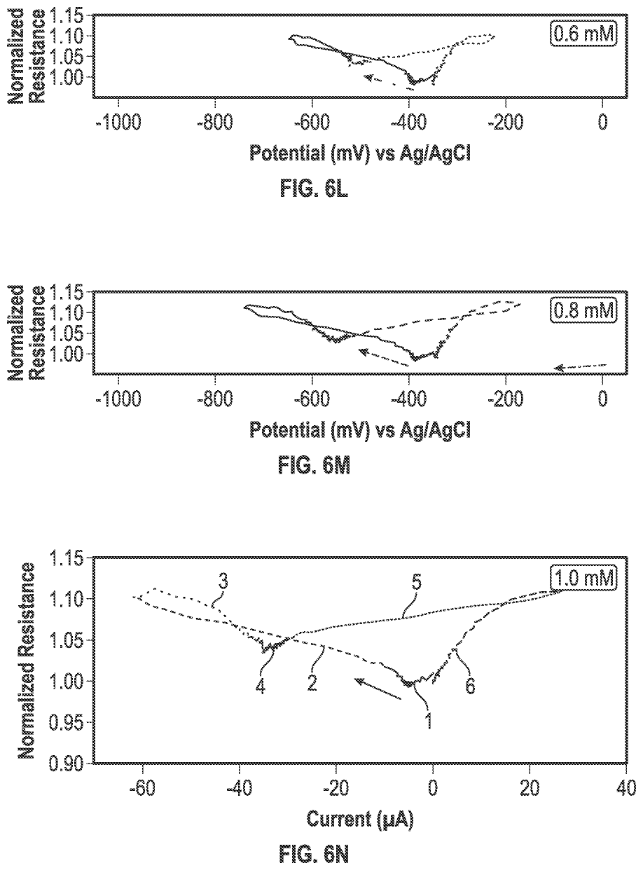

FIGS. 6A-6H are graph plots diagrams that show the effect of changing Fc concentration on CV and WE film normalized resistance vs. voltage. FIG. 6I-6N are graph plot diagrams adapted to show cyclic voltammograms and simultaneously measured WE resistance using Fc solutions with varying concentrations. FIG. 6A shows cyclic voltammograms of Fc in solution varying concentration. Arrows indicate directions. FIG. 6B shows normalized current and resistance peak (ΔR/R) vs. Fc concentration. FIGS. 6C-6G are graph plots showing resistance vs potential varying Fc concentration from 0.0 M to 0.8 M. FIG. 6H are graph plots showing resistance vs potential for 1.0 M Fc concentration. The inset shows the corresponding cyclic voltammogram. FIGS. 6I-6M are graph plots showing resistance vs current varying Fc concentration from 0.0 M to 0.8 M. FIG. 6N is a graph plot showing resistance vs current for 1.0 M Fc concentration. In FIG. 6H and FIG. 6N, numbers mark the corresponding 6 regions of the CV.

At zero Fc concentration, film resistance reversibly changes by ˜2.5% between zero and low voltage with some hysteresis. Resistance data exhibit plateaus but no intermediate resistance peaks. These observed resistance changes that plateau can be attributed to field-effect gating caused by the electric double layer generated by electrolyte ions in solution as previously mentioned. As Fc concentration increases, redox current increases. Correspondingly, ΔR/R increases to up to 7.5% at 1 mM Fc for this sample. FIG. 6B shows that the magnitudes of oxidation and reduction current peaks and resistance peaks increase linearly with Fc concentration as predicted by the proposed reaction mechanism and the kinetics model.

FIGS. 6I-6N are graph plots that plot film resistance against current using the same data. To aid in correlating such plots with current vs. potential CV plots, Applicants use [Fc]=1 mM as an example and divide the CV cycle into six regions—see colour codes and labels in FIG. 6H. along with inset and FIG. 6N.

In region 1, as the applied potential decreases from 0 to just above the oxidation potential, a small current flows due to EDL charging, and film resistance remains steady. In region 2, the applied potential crosses the oxidation potential, Fc in the EDL oxidizes to Fc⁺ and current quickly increases. Simultaneously, film resistance increases. In Region 3, Fc in the EDL depletes as it continues to oxidize to Fc⁺, while Fc⁺ diffuses out of the EDL and more Fc diffuses in. Oxidation current drops since the process is now diffusion-limited, and resistance decreases.

Regions 4, 5, and 6 are analogous to regions 1, 2, and 3, respectively. FIG. 6N. shows that in regions 2 and 3 (oxidation wave), as well as regions 5 and 6 (reduction wave), where current and resistance change significantly, ΔR/R is proportional to redox current over significant regions as predicted by Approach 1 and the kinetics model.

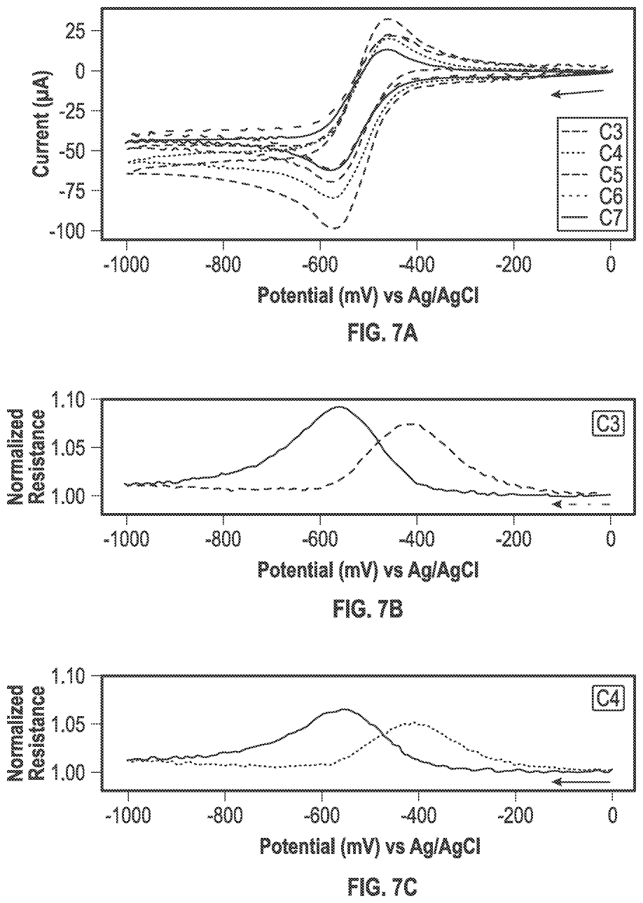

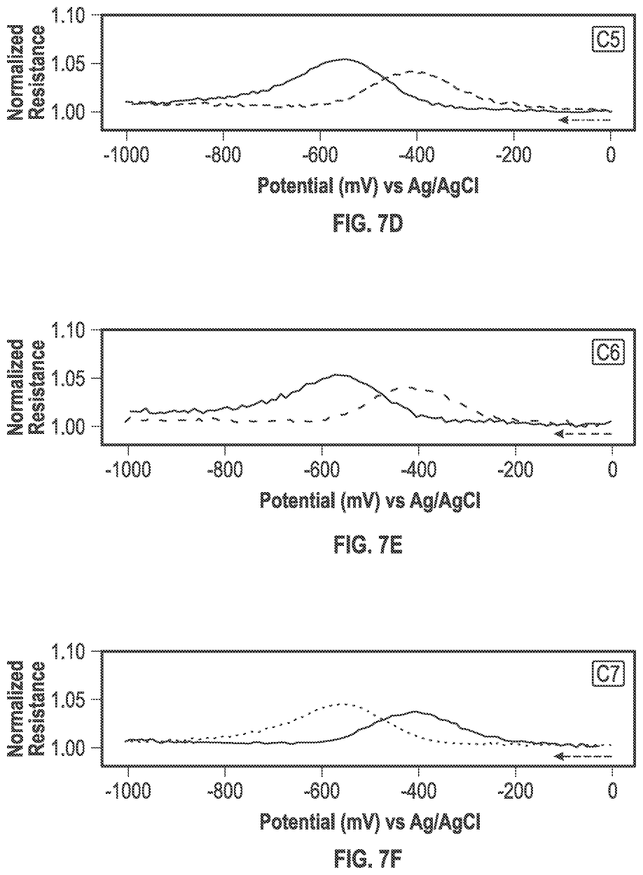

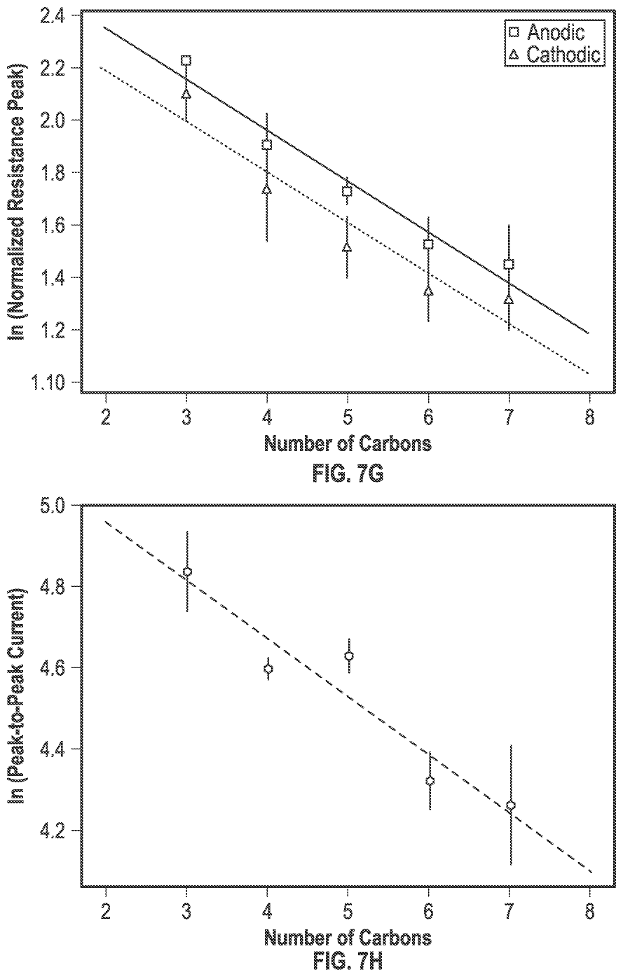

To probe the nature of the interaction between Fc and the Au WE film, Applicants performed measurements using WE films coated with self-assembled n-alkanethiol monolayers varying alkane chain lengths. Previous studies have reported that while n-alkane chains act as insulating spacers because they possess a large energy gap between their highest occupied molecular orbital (HOMO)-lowest unoccupied molecular orbital (LUMO), n-alkane chains with intermediate lengths (n˜6-18) can allow charge transfer via tunnelling. As n increases within this range, wavefunction overlap decreases. The rate of charge transfer and conductance both decrease exponentially. Here Applicants self-assemble n-alkanethiols with n=3-7 onto the Au WE electrode and perform CV and resistance measurements (see FIG. 7A and FIGS. 7B-7F, respectively).

FIGS. 7A-7F are a set of diagrams showing CV and Resistance with n-alkanethiol Coated Electrodes. FIG. 7A shows CV using WEs coated with n-alkanethiol self-assembled monolayers, n=3-7. FIG. 7B-7F show simultaneously measured resistance vs. potential data. FIG. 7G shows a log of anodic and cathodic resistance peaks vs. n. Slope of linear fit: β_{R}=−0.21±0.03 and −0.23±0.04 per methylene group for anodic and cathodic resistance peaks respectively. FIG. 7H shows a log of peak-to-peak current in CV vs. n. βₜ=−0.15±0.03 per methylene group.

Applicants observe that as n increases, CV current and resistance peaks attenuate. FIG. 7G and FIG. 7H are plot logs of resistance and current peaks vs. n as well as linear fits. The n-alkane length-dependent exponential decay of charge transfer is quantitatively described by R=R₀e^{βn}, where R₀ and β are constants.

A study measured CV current and determined that the through-bond tunnelling decay constant to be β=−1.14 per methylene group for (n=11-17). Similar studies report values ranging from −1.0 to −1.21.

Here, Applicants find βₜ=−0.15±0.03 per methylene group for redox current and β_{R}=−0.21±0.03 and −0.23±0.04 per methylene group for oxidation and reduction resistance peaks respectively. The lower value compared to previous studies can be attributed to lower n-alkanethiol packing density and higher disorder associated with smaller n. Also, given that the thermally deposited WE films are thin, Applicants limit self-assembly time to reduce potential Au film etching by the thiols and to improve reproducibility between samples (see also FIG. 9).

The observations that the resistance peaks decay exponentially on atomic scales and somewhat more rapidly than tunnelling current point to a Fc/Fc⁺-e⁻-Au film transition state mediated by short-range quantum interaction. Resulting changes in resistance are expected to be relatively larger for thinner films as the number of charges involved increases with surface area and the surface-to-volume ratio increases for thinner films. For example, for a thin film with 20 atomic layers and assuming ˜1 electron in the top atomic layer is involved, ΔR/R is expected to be on the order of ˜1/20=5%. ΔR/R observed here using films that are ˜10 nm thick range from a few percent to as much as 10's or 100's of percent. The very large values are attributed to inhomogeneities in such thin films that cause current bottlenecks in the film. Changes in these regions can have a large effect on overall film resistance. For metal films, e.g. thermally deposited gold, thicknesses in a range from a few nanometers to 1000 nm are desirable. Thinner films tend to have isolated island-like morphology that significantly reduce the conductivity of the film. For layered, van der Waals materials, e.g. graphene and transition metal dichalcogenides, single monolayers may be used. Estimating an inter-layer separation of ¼ nm, a 1000 nm thick film has 4000 layers. Assuming interactions with the surface layer dominates, fractional changes in resistance are ˜1/4000=0.025%. For reference, a temperature fluctuation, ΔT, generates a resistance fluctuation

$$\frac{Δ R}{R} = αΔ T ,$$

R is resistance and α is the thermal coefficient of resistance. Taking ΔT˜0.1° C., which can be achieved with some care, using and typically α˜few×10⁻³, gives

$$\frac{Δ R}{R} ∼ few \times {10}^{- 4} ∼ few \times {10}^{- 2} \% ,$$

this is comparable to fractional changes in resistance estimated above assuming a 1000 nm film and an interlayer separation of ¼ nm. As these are order of magnitude estimates, film thicknesses below 10,000 nm are preferred. Thinner films yield larger

$$\frac{Δ R}{R} ,$$

which are more easily measurable. Film thicknesses below 1,000 nm are preferred more. Film thicknesses below 100 nm are preferred even more and below 10 nm are preferred still even more. Materials may be >10 nm in both in-plane dimensions or in just one in-plane dimensions, otherwise they may be challenging to contact with source and probe electrodes.

By coating the WE with self-assembled n-alkanethiol monolayers varying alkane chain lengths, the ability to change the interaction strength between the quantum wavefunction of the Fc/Fc⁺ and the Au WE thin film is enabled. The n-alkanethiol monolayers act as spacing layers that limit the minimum distance between Fc/Fc⁺ and the Au WE thin film. As a result, the spatial overlap of the Fc/Fc⁺ and Au wavefunction can be controlled. The thiol functional group allows these molecules to bind to metals such as gold, silver, copper, platinum, titanium, chromium, and iron. Various functional groups may be used to bind molecules to other films as described in the literature. For example, a diazonium functional group can be used to bind molecules to carbon-based materials such as graphene, etc. More generally, molecules with multiple functional groups may be used, e.g. alkane, carboxylic acid group, an amine group, an alcohol group, a phenyl group, and a thiol function group. One functional group enables binding the molecule to the film. Another functional group enables target species of interest to bind to the molecule. For example, at least one of n-alkanethiol monolayer (where n is for example greater than equal to 2 and less than equal to 7), thiomalic acid, mercaptobenzoic acid, 2-aminoethanethiol, 3-mercaptopropanol, cysteine, 3-mercaptopropanoic acid, 11-mercaptoundecanoic acid may be used to coat a gold film. The thiol functional group binds to the gold film, and the carboxylic acid functional group can bind to various ions, such as copper. By using molecules with small backbones (e.g. ethane, phenyl, etc), the bound species will be in a proximity of the gold film on the scale of the wavefunctions of the bound species and the band states of the gold. The respective energy levels may be brought into sufficient alignment with the aid of at least one gating electric field. As a result, the resistance of the gold film can change.

The present disclosure may provide sensor applications for various species of interest. Since the sensor applications of this disclosure are electronics-based, they are inexpensive to fabricate, compact and portable; as a result, detecting metal ions using the sensor application of this disclosure is of interest for multiple applications. For example, embodiment of this disclosure can be used to detect heavy metals such lead and mercury. Such metals pose health concerns if they are released in the environment. Often they are detected using chromatography and atomic absorption apparatus, which are expensive, large and non-portable and therefore not amenable for environmental testing in the field. Accordingly, embodiments of the sensor applications described in this disclosure may be portable and used in-situ at a test site.

In this first example for heavy metal detection, the device operates as a measuring device, and is coupled to a material under test. The material under test can be the second material that is provided, for example in an electrolyte solution.

During the heavy metal detection, a current is provided (that operates as an actuator) and a computer processor is configured to track and record changes to impedance (e.g., resistance peaks). The first material and the second material have a quantum interaction, and that is evidenced through the tracked changes to impedance, for example, due to wavefunction overlap and wavefunction hybridization. Hybridization may occur when the working electrode and the material being measured come in proximity and energy is reduced, e.g. when sulfur combines with Au a stable bond is formed and excess energy is taken away usually in the form of light or heat.

The changes to impedance are recorded as a measurement output data set, and the measurement output data set can be analyzed to determine whether there is a match or parameter similarity. The measurement output data set can be generated in a format such as a plot of impedance vs. time. The characteristics indicative of heavy metal can be observed by using an array of sensors, each element of the array coated with molecules with various functional groups, for example carboxylic acids, thiols, and amines, which bind to different metal ions to different degrees. Further, gate voltages at which redox of the material being tested, e.g. heavy metal, and resulting changes to impedance occur can be measured. Such measurement output data can serve as a “fingerprint” indicative of the material being tested, e.g. heavy metal. Example sensors are described in Peter J. Chapman, Zhou Long, Panos G. Datskos, Richard Archibald, and Michael J. Sepaniak. Differentially Ligand-Functionalized Microcantilever Arrays for Metal Ion Identification and Sensing, Analytical Chemistry 2007 79, 18, 7062-7068. https://pubs.acs.org/doi/10.1021/ac070754x, the contents of which are hereby incorporated by reference. Example correlations between standard reduction potentials and corresponding element/compound(s) are shown in the Petr Vanýsek. Electrochemical Series, CRC Handbook of Chemistry and Physics, 2010, 89. http://www2.chm.ulaval.ca/gecha/chm2903/7_equilibres_electrochimiques/potentiels_reduction_CRC.pdf, the contents of which are hereby incorporated by reference.

An example fingerprint indicative of a material being tested, e.g. heavy metal, can include a gradual/steep increase of resistance/impedance which are indicative of transient resistance peaks as described in more detail in this disclosure. This transient increase in resistance/impedance can be practically characterized or determined through measuring one or more rates of change, where if a rate of change is greater than a threshold, the sensor tracks or records the transient increase as a specific analytical artifact object that is potentially indicative of a specific material, e.g. heavy metal. Conversely, in the absence of a rate of change is greater than a threshold, the sensor can be configured to record that no such specific material, e.g. a specific heavy metal, has been detected.

Different materials can have different fingerprints, and the rate of change can be just one of the example parameters that are used to characterize a fingerprint. In some embodiments, fingerprints and their detection parameters and thresholds can be stored as reference template fingerprints, and the sensor can be configured to run analysis results or extracted durations of interest (e.g., resistance/impedance charts) against fingerprints to conduct similarity analysis against template fingerprints, and if a sufficiently high similarity score is identified, a binary output can be established or a probabilistic output can be generated as an output data structure, which can then be consumed by a downstream mechanism to conduct one or more different remediation actions (e.g., sample/batch rejection) based on the determination.

In an example, a fingerprint may be formed by an array of responses from different sensors, e.g. sensors comprising different coating layers such as 2-aminoethanethiol, 3-mercaptopropanol, cysteine, 3-mercaptopropanoic acid, 11-mercaptoundecanoic acid, etc. to receive the array of response each providing impedance curves showing changes in impedance/resistance for the material tested (i.e. the second material). The coating layers comprise 2 functional groups; one which may bind to the working electrode/first material and another to bind to the second material (e.g. a metal ion).

Accordingly, the sensor approach described herein can be practically integrated into modifying the operation of physical machinery, which is useful in advanced manufacturing, materials testing, among other practical use cases. The system interacts with physical objects and provides analytical insight that can improve the overall functioning of the coupled physical machinery.

A computer processor, in determining that there is heavy metal, can for example, generate a binary output based on a detection threshold being met (e.g., greater than 95% certainty). In some embodiments, the output dataset can be provided to a quality control monitoring subsystem, which can then cause a mechanical rejection of an object having an amount of heavy metals detected greater than a threshold. For a manufacturing example, for example, this can include a sweeper arm being actuated that rejects an object if it fails test. In a process setting, for example, an alert can be generated informing an operator of the presence of the heavy metal. The operator can then take corrective measures, including removing the heaving metal and its source.

In another example, if environmental testing is conducted in the field and there is a detection of heavy metals, for example, in a particular site or premise, such as in soil or construction materials, a report dataset can be generated that can be coupled with a task scheduler system for automatic scheduling of further investigation of the site.

In another embodiment, sensor applications of this disclosure may be used to detect iron, which is of interest in the context stainless steel corrosion. For example, in fuel cells, which produce electricity from hydrogen, and in electrolyzers, which produce hydrogen using water and electricity, corrosion of stainless steel electrodes and resulting release of iron can lead to proton exchange membrane damage and ultimately device failure. Sensing iron in such devices would be desirable. However, using expensive and large apparatus such a chromatography, etc. is challenging. Low-cost, compact sensing, as provided by the present disclosure, would be desirable.

Similar to heavy metal detection, the system can be configured instead to observe the presence of iron. The difference between observing iron as opposed to heavy metal can include use of an array of sensors, each element of the array coated with molecules with different functional groups such that relative binding of different metals to different functional groups serves as a fingerprint for the metal. Application of gate voltage can further aid in identifying the metal, as different metals may have different gate voltages at which redox occurs. This can be used in the fuel cell manufacturing or electrolyser analysis process, which similar to heavy metal detection, can include the rejection of devices having an iron content greater than a threshold.

In another embodiment, sensor applications of this disclosure may be used to monitor interaction between various species and catalysts. This has application for detecting poisons that reduce catalyst activity or for developing catalysts that exhibit increased activity. For instance, the thin film electrode may be a catalyst, the species may be a catalyst substrate and CV may be performed to monitor redox as is conventionally performed. In addition, sensor applications according to this disclosure may enable monitoring catalyst (thin film)-substrate interaction via thin film resistance. By Sabatier's principle, ideally catalyst-substrate interaction should be neither too strong nor too weak. Thus by also enabling monitoring catalyst-substrate interaction via catalyst resistance, applications of the present disclosure can serve as an aid to optimize catalyst activity. For example, if poison is detected at the sensor located upstream of a catalyst, the source of poison may be removed before the main catalyst is damaged. To gain further insight into the microscopic processes involved, Applicants performed DFT calculations for a 490 atom Au slab with 25 Fc molecules.

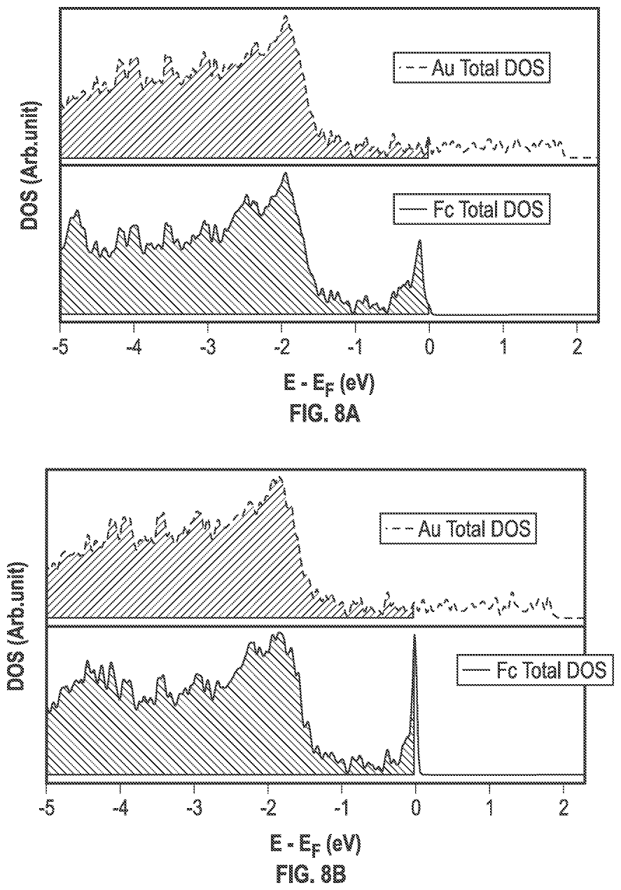

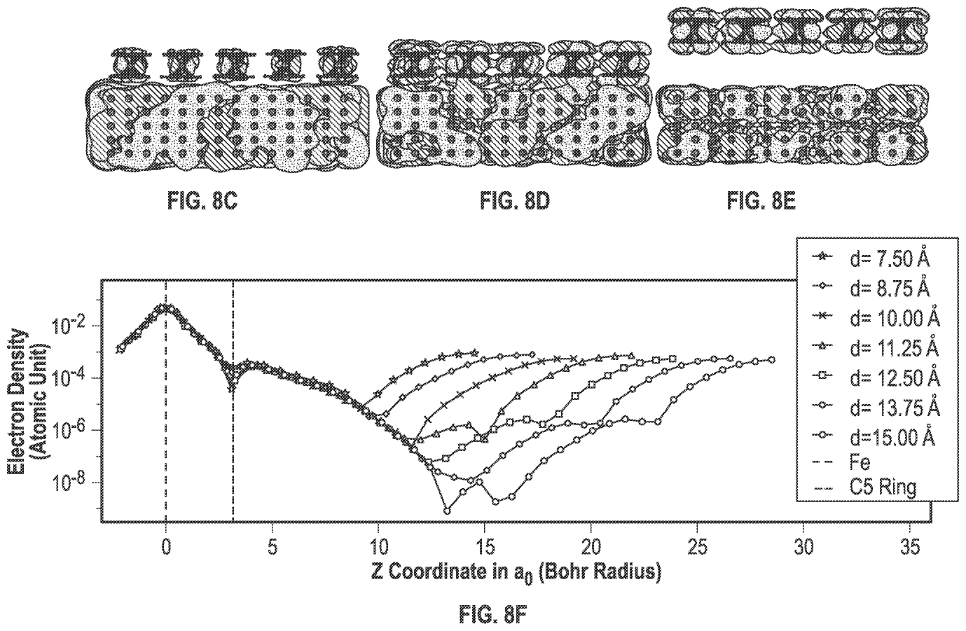

FIG. 8A-8F is a set of diagrams showing DFT Modelling for 25 Fc molecules and an Au slab with 490 Au atoms. FIG. 8A is a graph plot that shows Au and Fc density of states (DOS) with 0 charge (q). FIG. 8B is a graph plot with Δq=+18e. FIG. 8C shows electronic wavefunction of the Au and Fc system with Δq=0 and Fe—Au separation=5 Å, FIG. 8D shows electronic wavefunction with Δq=+18e and Fe—Au separation=5 Å, and FIG. 8E shows electronic wavefunction at Δq=+18e and Fe—Au separation=10 Å. FIG. 8F is a plot of electron density vs. z between Fe and Au atoms. z=0 locates the Fe atoms and positive z points towards the Au slab. Dashed lines denote position of the Fe atom and cyclopentadienyl rings.

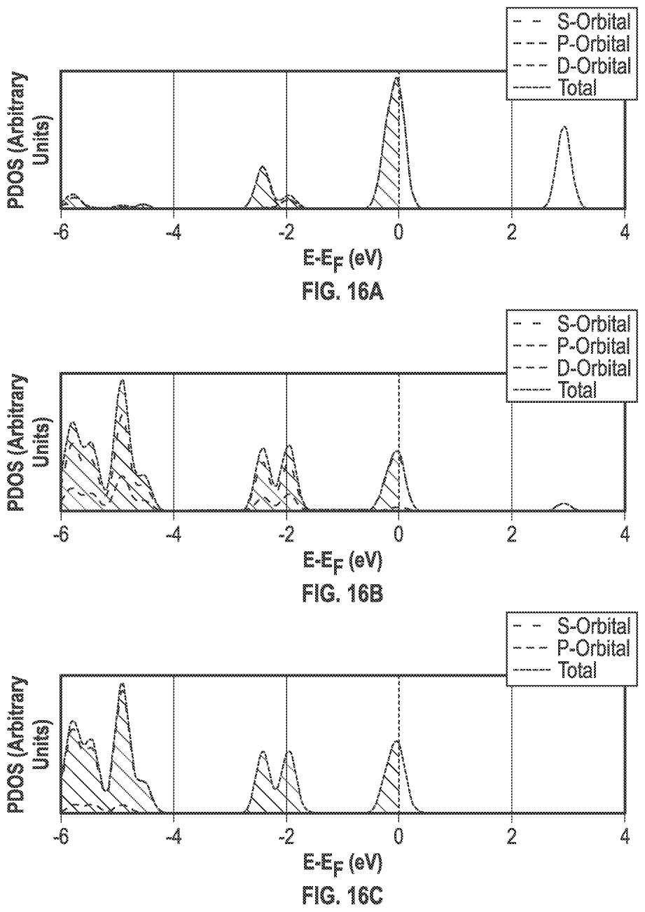

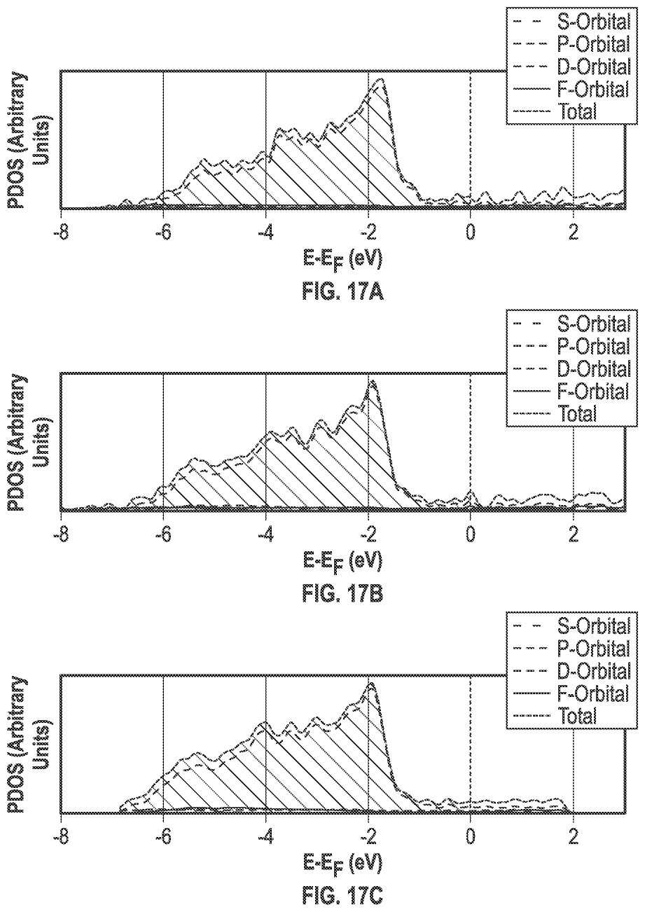

FIG. 8A shows the calculated total density of states (DOS) for the Au slab and Fc in two charge states—neutral and +18e—over a wide range of energies. The Au DOS exhibits a broad feature around the Fermi level and a large increase below −1.5 eV, which agree well with literature results. The Fc DOS exhibits a feature just below the Fermi level with significant contributions from the iron- (d-) as well as some contributions from carbon- and hydrogen-orbitals (see Appendix, FIGS. 16A-16C). Interestingly, Fc DOS of the combined Au+Fc system also exhibits features below −1.5 eV. DOS for isolated Fc molecules do not exhibit these features, but the DOS for an isolated Au slab does, predominantly due to Au d-orbital contributions (see Appendix, FIGS. 17A-17C). This indicates that Fc in the combined Au+Fc system has acquired this feature from the Au.

FIG. 8B shows that, as expected, the Fermi level shifts down as electrons are removed. For Applicants' system, +18e charge brings the Fermi level and Fc states into resonance and enables redox charge transfer.

FIGS. 8C and 8D show the isosurfaces corresponding to electron density of 0.001 qₑ/a₀³ (a₀=Bohr radii) with system charge of 0 and +18e respectively. For Δq=0, regions with low electron density between Fc molecules and between Fc and the gold slab are more pronounced than for Δq=+18e. FIG. 8E. shows electron density when the Fc molecules are geometrically constrained to be further (10 Å) from the Au surface. This models the experiment where an n-alkanethiol insulating coating is self-assembled onto the Au film surface and acts as a spacer layer between the molecules and the Au film. This is an approximate description as it neglects molecular energy levels and charge transfer from the Au to the thiol to form the thiolate. Nevertheless, it provides a reasonable semi-qualitative picture given the wide HOMO-LUMO energy gap for n-alkanethiols. The calculation shows that increased separation results in regions with low electron density between Fc molecules and the Au slab.

FIG. 8F plots the electron density in the region between the Fc molecule and Au surface as a function of distance from the Fe atom at Δq=18e. Inside the Fc molecule, electron density decreases exponentially from the Fe atom to the cyclopentadienyl ring. Away from the molecule, electron density decreases with a slower exponential decay between 4 to 8 Bohr radii (a₀) from the Fe atom. This corresponds to the wavefunction of Fc. Near the Au surface (right-most data point of each series corresponds to the top Au layer) the electron density shows a staircase behaviour. Close to the Au surface, electron density decreases rapidly away from Au surface on a length scale of 5 a₀ and then again decreases rapidly from 5 to 15 a₀. The first region corresponds to the atomic wavefunction of individual Au atoms and the second region to the crystal Bloch-type wavefunction. A similar assignment has been previously reported in the literature.

The Bloch wavefunction is responsible for transport properties of the Au film. As the Fc molecules and Au slab are brought closer and their energy levels align, their wavefunctions overlap, charge exchange occurs, and we observe that Au resistance increases. If the respective wavefunctions associated with this transition state not just overlap but hybridize as well, then Au wavefunction acquires a partially localized, molecular character as charge exchange occurs, in qualitative agreement with observation of peaks in Au resistance. Such behaviour is consistent with our calculations showing that Fc acquires d-orbital contributions from Au as discussed above.

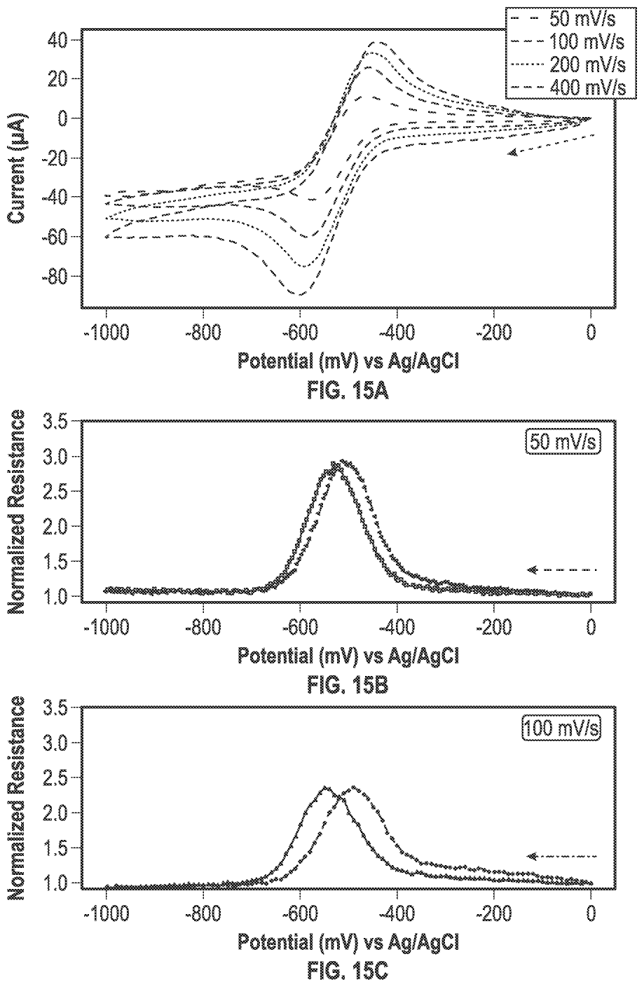

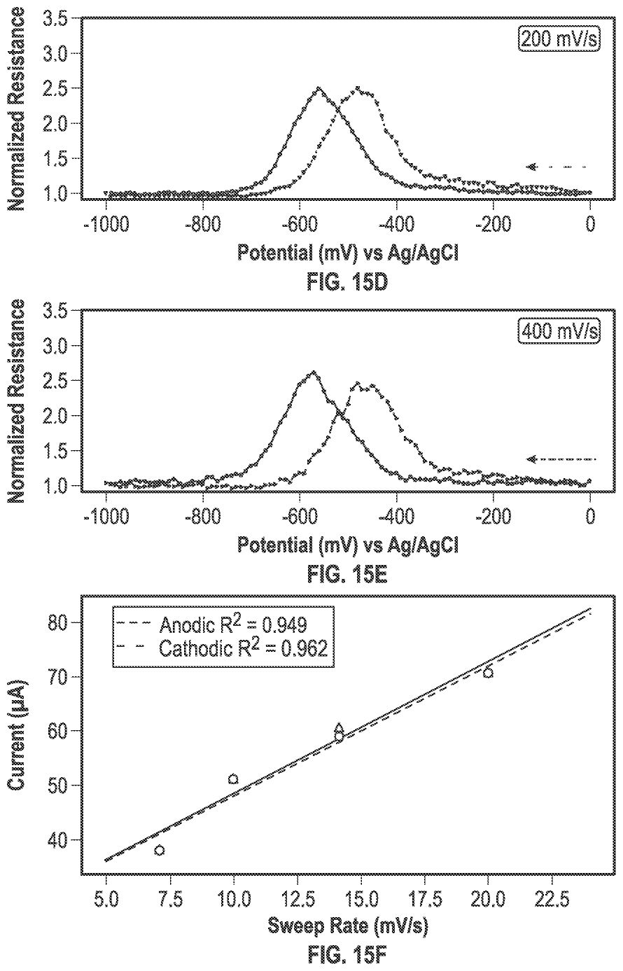

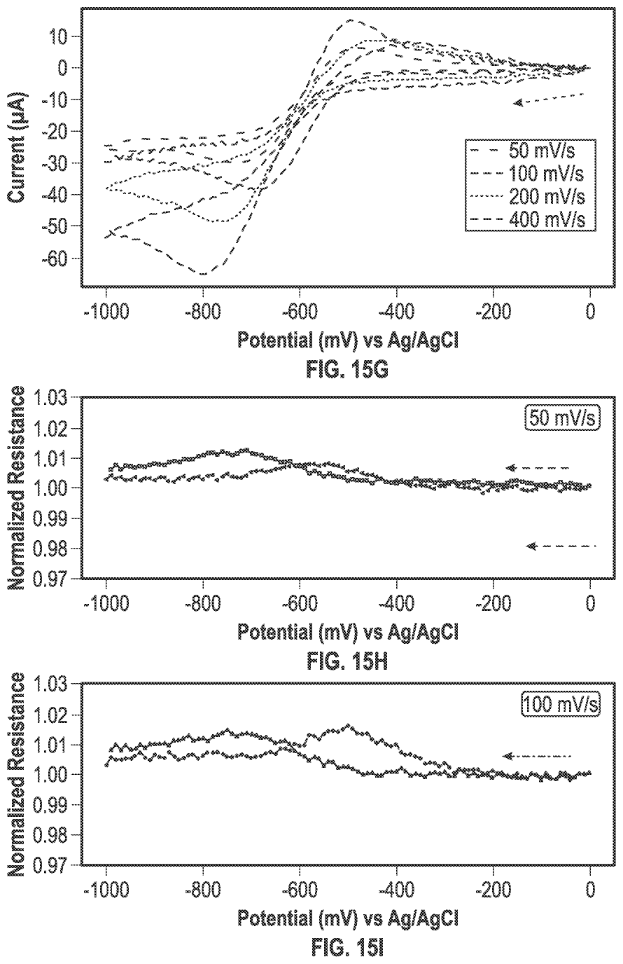

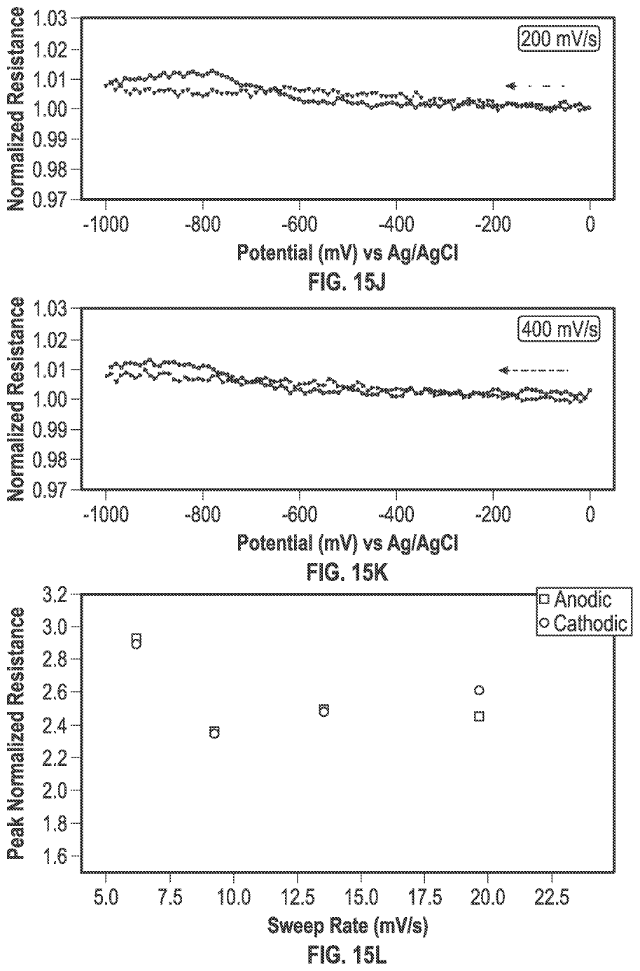

Applicants note that not all redox events proceed via this pathway involving short length scales. Redox can also occur over longer length scales via tunnelling, for example. Also, the short length scales likely include surface sites. The probability of such sites being filled increases linearly with Fc concentration in a Langmuir isotherm model. As a result, the number of transition states, resistance peak height and redox current all increase linearly with Fc concentration as discussed in the context of FIG. 5. Instead, if one keeps Fc concentration fixed and vary voltage sweep rate, redox current increases as the square root of the sweep rate due to diffusion-limited processes, which are likely associated with redox over longer length scales (see Appendix, FIGS. 15A-15F). In this case, resistance peak heights do not change significantly even though Applicants vary sweep rates 8-fold and redox current increases 2-fold. This underscores the fundamentally different redox mechanisms that can occur on different length scales.

FIG. 9 is a plot showing n-hexanethiol self-assembly resistance vs time for a film immersed in a n-hexanethiol solution. The blue dotted line is an exponential fit to the first 10 data points. The red dotted line is a linear fit to the final 20 data points. The gray region denotes the transition region where both models fit the data reasonably well.

To demonstrate resistance change actuated by charge exchange in another context, FIG. 9 shows Au film resistance as n-hexanethiol molecules self-assemble and bond to the surface in real time.

From t=0 to t=35 minutes, the resistance increases initially rapidly and then more slowly. An exponential fit (dashed line) yields good agreement with the data in this region. This behaviour can be attributed to the self-assembly of n-hexanethiol onto the Au film surface as the S—Au bonds localize Au electrons and, as a result, increase film resistance.

After t=35 minutes, film resistance increases linearly. This slow step may be due to etching, i.e., molecules detach from the surface and remove Au while other molecules bind; also, molecules may reorganize on the surface, allowing additional molecules to bind. Such fast-then-slow kinetic steps are consistent with previous reports. Also, the observed increase in film resistance by n-hexanethiol self-assembly is consistent with the depletion of Au film surface free electron carrier density and the formation of a surface dipole, as has been previously reported.

In summary, Applicants observe transient resistance peaks during metallocene redox using thin film Au WE. It is proposed that the resistance peaks are generated by charge localization by a transition state which occurs during charge exchange between electronic states of redox-active molecules and the metal. Combined with a kinetic model, this mechanism predicts that the resistance change should increase linearly with Fc concentration and redox current as observed. The quantum hybridized nature of the charge exchange and the transition state is supported experimentally by an exponential dependence of transient resistance peak height and redox current with Fc/Fc⁺-Au film distance. Density functional theory modelling of our system provides further support.

Finally, Applicants use the CET to monitor n-hexanethiol self-assembly, i.e., charge transfer from Au to thiol on the CET's surface in real time. These results are significant as they provide a more detailed picture of mechanisms involved in charge exchange, in addition to tunnelling that is known to occur at longer length scales. Also, they provide an intriguing perspective that a CET is gated by a fundamentally quantum mechanical mechanism, and conversely, they point to an important application of CET as a means for probing and potentially exploiting such quantum phenomena.

### Methods

Glass microscope slides 1 mm thick are cut to form substrates 8×25 mm in size. The cut substrates are ultrasonically cleaned for 10 minutes in methanol and then acetone. Next, the substrates are rinsed with deionized water and cleaned in a boiling mixture of 98% sulfuric acid and 30% hydrogen peroxide (3:1 volume ratio) for 20 minutes. Finally, the substrates are rinsed with deionized water and dried in an oven.

For device fabrication, Applicants use shadow masks and thermal evaporation to fabricate solder pads and leads. First, a 25 nm Cr (Kurt J. Lesker) adhesion/seed layer is thermally evaporated onto glass substrates at a pressure of 5×10⁻⁶ mbar. Then, 100 nm Au (Kurt J. Lesker, 99.999%) solder pads and leads are thermally evaporated onto the Cr layer. The geometries for both layers are defined by the same shadow mask. Next, an 8 nm Cr adhesion/seed layer and Au test films ranging from 10 nm to 50 nm are deposited on top of the leads using the same shadow mask+thermal evaporation method. Devices are stored at room temperature under an inert argon atmosphere.

For conductance measurement, 30 AWG enamelled copper wires are soldered to the device electrodes using indium as solder. Due to the high conductance of the Au films, the 4-probe lock-in conductance measurement method is used to eliminate the effect of contact resistance. 300 Hz 10 mV AC voltage is applied to the source electrode by a function generator. The AC current is measured by a trans-impedance amplifier and a lock-in amplifier. The AC voltage drop across the inner electrodes is measured using voltage followers with high input impedance and another lock-in amplifier.

For cyclic voltammetry, cobaltocene is purified by vacuum sublimation before use and kept under a nitrogen atmosphere during CV. For the purpose of characterization, CV of Fc and cobaltocene are performed using a 3-probe electrochemical cell, with tetrabutylammonium hexafluorophosphate (Sigma-Aldrich, 99%) in acetonitrile as an electrolyte solution and platinum mesh as the counter electrode. A silver wire immersed in 3.0 M KCl solution is used as a Ag/AgCl reference electrode. Potential sweeps are generated and redox currents are measured using a custom potentiostat.

For ionic liquid gating, Diethylmethyl(2-methoxyethyl)ammonium bis(trifluoromethylsulfonyl)imide (DEME-TFSI, Sigma-Aldrich, 98%) is used as the IL. A droplet of IL is applied onto the substrate to span the WE (Au film) and CE. The potentiostat sweeps the voltage of the CE, which acts as a gating electrode in this measurement, while the resistance of the test film is measured using the 4-probe lock-in technique.

In respect of self-assembled n-alkanethiol monolayers for electrochemistry, CETs are immersed for 3 hours in 10 mM acetonitrile n-alkanethiol solutions (n ranges from 3 to 7). Devices are rinsed in a steady stream of acetonitrile and then used for CV measurements.

DFT calculations are performed in the Gaussian and plane waves method as implemented in the CP2K software package. The double-ζ valence polarized (DZVP) Gaussian basis set and accompanying Goedecker-Teter-Hutter (GTH) pseudopotentials along with Perdew, Burke, Ernzerhof (PBE) exchange-correlation functional is used in the calculations. Auxiliary plane wave energy cutoff is set to be 600 Ry. Geometry optimization is performed on Fc and the molecule is allowed to relax fully. Au slab containing 490 atoms in FCC lattice with lattice parameter of 4.17 Å is used. A lateral (5×5) supercell with 5 Au layers and a vacuum region of 30 Å above Au slab is used.

### Low-Temperature Redox Gating

As noted above, Applicants demonstrated that by measuring the resistance of Au thin film WE during cyclic voltammetry (CV), one can detect charge localization by a transition state during redox charge exchange. This transition state can be seen as an example of molecule-band hybridization which has great theoretical importance.

In this section, Applicants describe bringing the system to cryogenic temperature to minimize resistance caused by electron-phonon scattering in order to explore potential emergent phenomena relating to molecule-band hybridization.

Important obstacles must be overcome in order for electrochemistry to be performed at cryogenic temperatures. In the section above, Applicants were able to use CV to shift molecule energy levels in and out of resonance with the metallic band states. However, at cryogenic temperatures, the solvent and electrolyte freezes. Ionic transport stops, so shifting molecule energy level by charging up an electric double layer (EDL) is no longer possible.

Two modifications to the present CET device that can be made to overcome this obstacle. The first is to switch from an organic solvent-based electrolyte solution to one that is based on ionic liquid (IL). ILs offer the advantage of being cryogenic compatible to lower temperatures. For instance, DEME-TFSI has a glass transition temperature of 180 K and is widely used for cryogenic electrolyte gating experiments.

By dissolving metallocene molecules (ferrocene and cobaltocene) in IL, Applicants can still perform CV to change the energy level and oxidation state. When the device is cooled and the IL freezes, these states can be preserved and their effect on the material of interest can be measured. The second challenge with cryogenic measurement is to control the material Fermi level independent of the molecule energy levels. To change the material energy level, the approach can use an electrostatic back gate 310. This provides another level of control over the tuning/detuning of the molecule and material energies. Further, the back gate can shift material energy levels relative to the molecule energy levels sufficiently to induce redox charge transfer between the material and the molecule (or more generally other redox species). In one embodiment, if the redox species is in close proximity to the material, the back gate can induce redox charge transfer between the redox species and the material without need of an electrolyte, counter electrode or reference electrode. Back gate charging may also enable Fermi level to be modified significantly. In another embodiment, the material may be coated, such that the coating has at least functional groups that has an affinity for a redox species, for example, metals and metal ions. In a preferred embodiment, the functional group is within 10 nm of the material to enable hybridization between material and redox species quantum states. In a more preferred embodiment, the functional group is within 1 nm of the material. In one embodiment, the distance between the functional group and the material may be determined via the length of a molecule, for example, an alkane chain with fewer than 8 carbons or a conjugated chain comprising double of triple bonds. In another embodiment, a sensor may comprise an array of CETs with a variety of coatings and functional groups with a variety of affinities to various redox species. A given metal ion, for example, may bind to different CETs in the array with different affinities, providing a fingerprint of the metal ion which can vary depending on the metal ion. Further, the back gate voltage at which redox occurs can provide another fingerprint. Such fingerprints can aid in monitoring the presence of the redox species and aid in its identification. Such CETs enable redox to be performed in a large variety of settings; for example, redox active species may be detected in situ via redox in deionized water without electrolyte, which is not possible using current art method and apparatus. Preferably, the WE comprises a material to reduce the effect of screening of the electric field generated by the back gate. For example, the material may comprise a semiconductor, a thin metal film or a 2D material. More preferably, the the WE comprises one monolayer to reduce the effect of screening still further. In an embodiment, the substrate may be switched to degenerately doped Si with a thin SiO₂ dielectric layer. The degenerately doped Si offers significant conductivity at cryogenic temperatures while still offering the option of having high-quality SiO₂ thermally grown to provide an insulating dielectric layer. The Si and material of interest effectively act as a capacitor with the SiO₂ as the dielectric. The material under investigation is changed from 10 nm Au film to monolayer graphene since a metallic film will shield the electric field and prevent it from reaching the material's top surface where the IL and Fc contact. 300 nm dry thermally grown oxide is chosen since it has been shown to reliably insulate against 200 V/μm electric field strength. As an added benefit, graphene on 300 nm SiO₂ on Si has been shown to have excellent optical contrast and make graphene visible under a microscope.

FIG. 3E illustrates an example back gate electrode 310. In an embodiment, the at least one gate electrode of apparatus 300 comprises back gate electrode 310 for inducing a redox change in the second material. Apparatus 300 may comprise at least one of gate electrode 301 and back gate electrode 310. Processor 313 may be configured to measure a back gate voltage at which the redox change occurs to determine the material characteristic of the second material. A dielectric layers 311, 312 may be selected to enable at least one gate electric field to shift the at least one first material quantum energy level relative to the at least one second material quantum energy level for a charge sharing between the first and second material 302, 322 respectively. In an embodiment, a (second) dielectric layer 312 may be positioned between back gate electrode 310 and the first material 302 (i.e. the working electrode). Second dielectric layer 312 may be a solid state material. In an example, the second dielectric layer 312 may comprise SiO, back gate 310 may comprise silicon (e.g. back gate 310 may be a silicon wafer), and first material 302 may comprises graphene. Dielectric layer 311 may be positioned between first material 302 and liquid 308 comprising the second material. An advantage of back gate 310 arise in situation where liquid 308 does not comprise ions, e.g. if liquid 308 is deionized water, meaning that there are no ions for a gate electrode 301 to create an electric field. In this example, when voltage is applied to back gate electrode 310 the electric field shifts the energy level of the first material (e.g. monolayered graphene) to act as a capacitor allowing a redox reaction to occur with the second material in liquid 308.

The experimental procedure is described as follows in an non-limiting example: fabricate a sample with graphene as the WE, then perform CV with metallocene in IL. When CV voltage reaches the oxidation/reduction peak, lower the temperature to freeze the Fc and IL in order to keep the Fc molecules in the hybridized state. Finally, resistance vs temperature can be measured at different back gate voltages.

### Modifications to Device Geometry for Cryogenic Measurements

In the experiment of the sections above, the device consists of thin Au film contacting several electrodes ending in circular solder pads. All electrodes are thermally evaporated onto a glass substrate. Glass is an non-limiting example of a substrate and other substrates may be used such a silicon. Low-temperature experiments can be performed at cryogenic temperatures in a PPMS. This imposes special requirements on the size of the sample, the material of the reference electrode, and the insulation technique between probing electrodes.

The size of the Quantum Design PPMS™ puck permits a maximum sample size of about 10×12 mm. Sample fixtures and shadow masks for thermal evaporation can be fabricated with CNC machining and laser cutting, respectively.

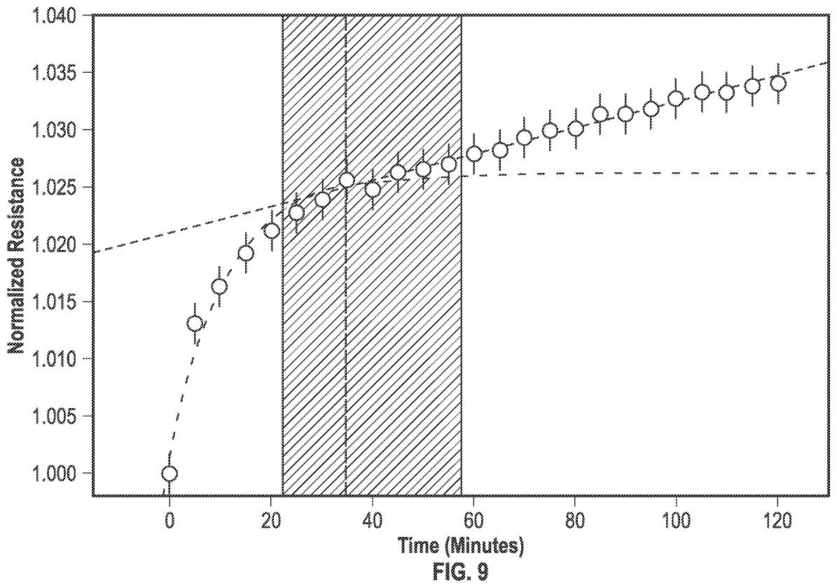

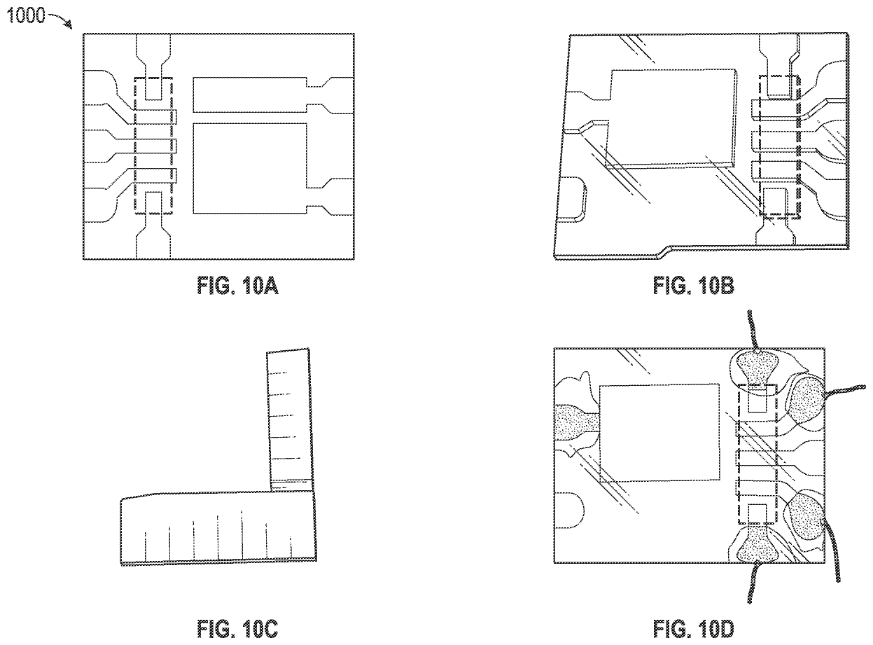

FIGS. 10A-10D show CAD and optical image of a PPMS™ compatible sample 1000. FIG. 10A is a CAD diagram showing a sample, with all dimensions in mm. FIG. 10B is an optical image of thermally evaporated electrodes on glass substrate. FIG. 10C shows a pseudo reference electrode, Ag foil coated in AgCl. FIG. 10D is an optical image of thermally evaporated electrodes on glass substrate with Apiezon N™ grease coating indium solder beads. Gold appears darker in FIG. 10D than in FIG. 10B due to a different tilt angle of the sample in the image. All scale bars are 2 mm in length.

In the room temperature experiment, the standard Ag/AgCl aqueous reference electrode is used. Another obstacle that arises at cryogenic temperatures is that the aqueous KCl solution will be frozen. Applicants choose to use a Ag/AgCl solid-state pseudo reference electrode (PRE) instead. The PRE is made by cutting a Ag foil into an L-shape as shown in FIG. 10C. One leg of the L is soldered to a solder pad on the substrate, and the other leg cantilevers above the WE in order to make contact with the ionic liquid electrolyte.

The AgCl layer is deposited on the Ag foil by dipping the Ag foil in a solution of 50 mM FeCl₃ in DI water for 60 seconds. The FeCl₃ chemically oxidizes the Ag foil to produce a layer of durable AgCl. The formation of the thin AgCl layer is confirmed by a darker colour. FIG. 10C shows the fabricated PRE. Although the use of a solid-state pseudo reference electrode may cause some deviations from its aqueous version due to the lack of thermal equilibrium between anion/cation in adjacent phases, it still acts as an internal reference for the redox process. By comparing the redox potential of a reference system (e.g., Fc/Fc⁺) in the pseudo reference case and the aqueous reference electrode case, one could calibrate and compensate for the deviations.

As visible from FIG. 10B and FIG. 10D, for the desired redox reaction to occur, one must place a drop of IL on the sample surface in such a way that the IL wets the working, counter and (pseudo) reference electrodes. It is difficult to control where the IL flows. In order to prevent the IL from touching the indium solder and causing undesired reactions and shorts, one must insulate the indium solder bead from the IL. A material that serves this purpose is Apiezon N™ grease. This compound is intended as a vacuum grease compatible with cryogenic temperatures and high vacuum. In practice, first, a small droplet of the grease is applied on the solder bead surface, next gentle heat is applied (e.g. through the radiant heat of a soldering iron) to the grease. When the grease melts, it wets the solder bead and forms an even insulting layer that will isolate the IL. FIG. 10D shows the Apiezon N™ grease coating applied.

### Gating Thin Film Using Ionic Liquid Electrolyte Redox

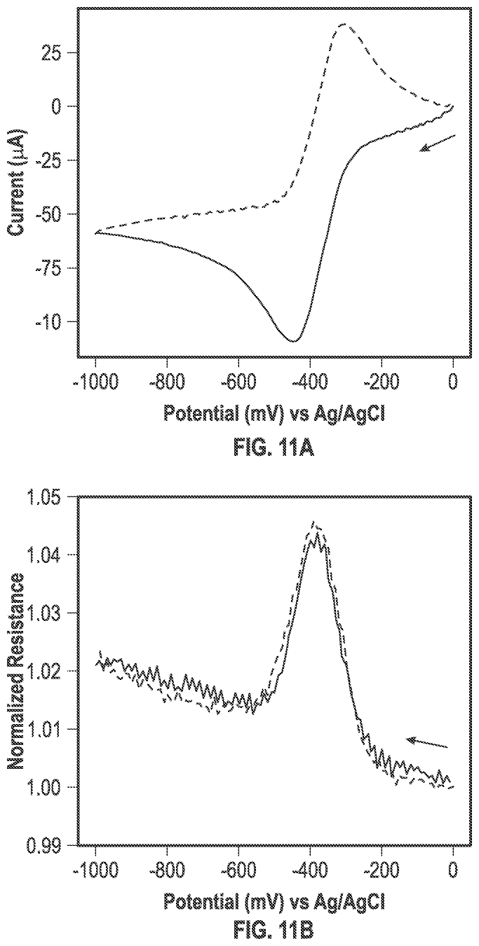

The first proof-of-principle experiment conducted tests the solubility of Fc in the IL DEME-TFSI. Furthermore, Applicants examine the feasibility and stability of performing CV and resistance measurement using the PPMS™-compatible samples described in above in this specification with Fc dissolved in IL at room temperature. Similar experiments are performed with cobaltocene (Cc). The samples consist of 10 nm thermally deposited Au WE (translucent region FIG. 10B) and Ag/AgCl solid-state PRE. Results are shown in FIG. 11A and FIG. 11B. FIGS. 11A and 11B shows cyclic voltammetry and simultaneous resistance measurement of 1.0 mM Fc in DEME-TFSI at room temperature, respectively. Arrows indicate the direction of the potential sweeps. Lighter and darker coloured lines indicate the oxidation and reduction sweeps, respectively.

Applicants can observe a similar CV as compared to CV of Fc in solution, for instance, FIG. 4E, 4F. The redox potential is shifted by ˜+100 mV as expected for the PRE.

Applicants can observe clear transient resistance peaks just as in the Fc in solution case. This confirms that at least 1.0 mM of Fc can be dissolved in DEME-TFSI and that the ionic liquid can facilitate CV measurement and perform a similar role as the acetonitrile+electrolyte solution. When Fc is dissolved in the ionic liquid as in this measurement, the ionic liquid acts as both a solvent for Fc and as an electrolyte which replaces the acetonitrile+electrolyte solution. The use of ionic liquid offers several key advantages including: negligible vapour pressure compared to organic solvents, thermal stability over a wide range of temperatures, wide electrochemical window which enables stronger EDL gating effect, and high ionic conductivity which enhances kinetics of electrochemical reactions. A wide range of ionic liquids with different properties are commercially available. Suitable ionic liquids can be chosen for different applications.

### Graphene Sample Fabrication and Characterization

In this experiment, monolayer graphene is deposited on a glass substrate to replace 10 nm Au film as the WE. Two-terminal resistance measure is performed to test graphene adhesion, quantify sheet resistance and estimate contact resistance. Next, IL electrolyte gating is performed. Resistance measurement results show the characteristic semi-metal electronic structure of monolayer graphene and are in qualitative agreement with literature results. Finally, the resistance vs time of graphene during IL addition is tested and results show evidence of surface doping caused by surface adsorption of IL.

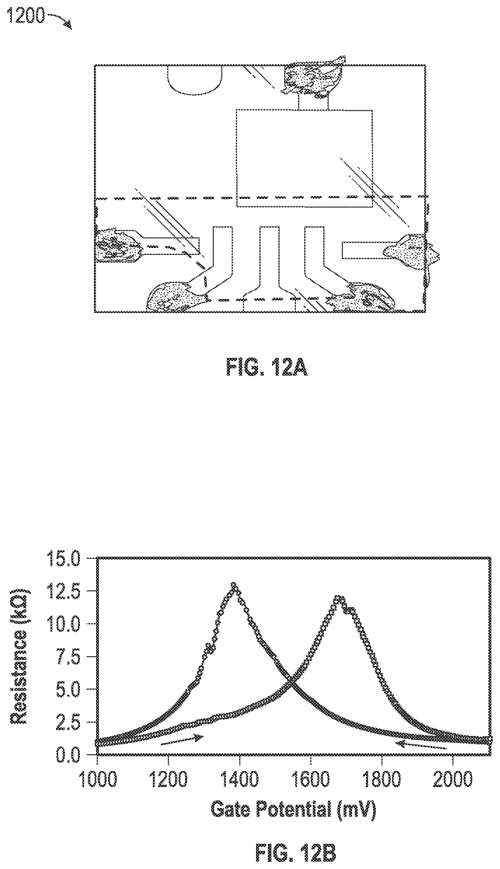

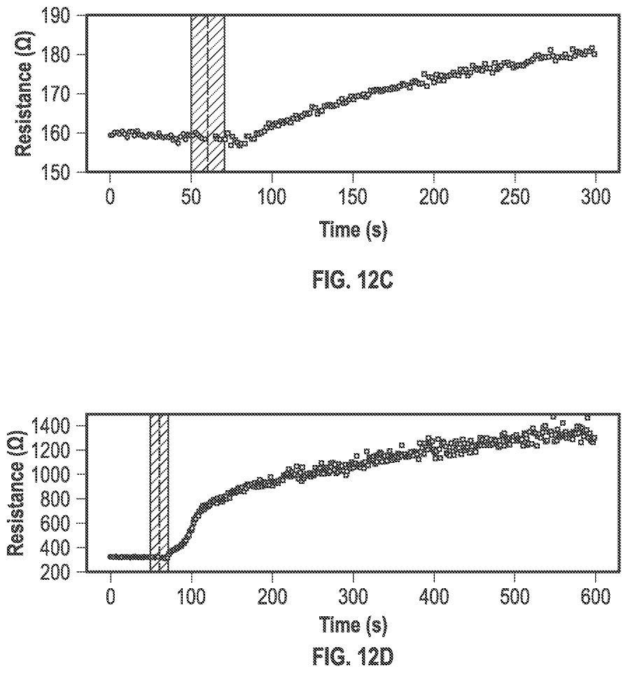

FIG. 12A shows an optical image of a sample with graphene WE 1200. The region covered by graphene is shown in the orange box. Due to the low optical contrast, the exact size of the graphene sheet is difficult to see. However, in future experiments, the substrate will be replaced by Si with a 300 nm SiO₂ layer which has been shown to offer excellent optical contrast in the visible spectrum.

The monolayer graphene can for, example, be purchased from Graphenea™. Easy transfer (graphene on polymer film) is first cut into the desired size. The polymer film/graphene/sacrificial layer stack is placed in DI water. The polymer film then separates and the graphene/sacrificial floats on water. Next, the substrate is used to “fish” the graphene out of the water. The substrate/graphene/sacrificial layer is dried in air for 30 minutes, then annealed in an oven at 150° C. for 1 hour. It is then stored under vacuum for 24 hours to prevent graphene detachment. To remove the sacrificial layer, the substrate/graphene/sacrificial layer is heated to 450° C. for 2 hours under a nitrogen atmosphere. Finally, the CE and other probing electrodes are deposited by thermal evaporation using the same shadow mask discussed in section 2 with 25 nm of Cr adhesion layer and 100 nm of Au. The prepared sample is stored under Ar atmosphere in preparation for measurement.

Two-terminal resistance measurement Is performed to give a quantitative estimate of contact resistance. Indium solder is applied to the Au solder pads and multimeter leads are pressed into the indium beads to achieve good electrical contact. The electrodes contacting the graphene film are named E1, E2, E3 in order. R₁₂, R₂₃ and R₁₃ are measured and compared. The sum of adjacent resistance (R₁₂+R₂₃) differ from the total resistance R₁₃ by ˜1%. This indicates the contact resistance between the Cr—Au electrode and graphene is very low. The typical value of R₁₃ is on the order of kΩ, so contact resistance is only on the order of 10Ω. By considering the geometric dimension of the graphene sheet, the sheet resistance of graphene is estimated to be 519Ω/□. This is comparable to the value of 670Ω/□ by Peng et al.

The electronic structure of graphene in the tight binding approach is given by:

$${E}_{\pm } ( k ) = \pm t \sqrt{3 + f ( k )} - {t}^{′} f ( k ) \qquad ( 3 )$$

$$f ( k ) = 2 cos ( \sqrt{3} {ak}_{y} ) + 4 cos ( \frac{3 {ak}_{x}}{2} ) cos ( \frac{\sqrt{3} {ak}_{y}}{2} ) \qquad ( 4 )$$

where t≈2.8 eV, 0.02t<t′<0.2t, a≈2.46 Å. Near the K (K′) points of the Brillouin zone, the electronic dispersion is linear. These structures are known as the Dirac cones. In addition, the conduction band and valance band meet at K points (Dirac point) where graphene exhibits a semi-metal character—zero density of state but no band gap. It is possible to shift the Fermi level of graphene above or below the Dirac point by doping/gating techniques. When the Fermi level is in the valance or conduction band, the density of states is no longer zero, which results in the increase of graphene conductance.

Applicants can use electrolyte gating technique with IL to shift the Fermi level of graphene. A voltage is applied to the CE. To lower the complexity of the measurement and to eliminate sources of interference, Applicants choose to reference the CE voltage to ground potential rather than Ag/AgCl PRE similar to FIG. 4B. The gate potential is varied while graphene resistance is measured by 4-probe method. The result is shown in FIG. 12B. Arrows indicate potential sweep direction. Sweep rate=50 mV/s.

Two resistance peaks can be observed corresponding to the forward and reverse potential sweep. This is in good agreement with band structure predictions and with literature results. It is notable that the forward and reverse potential sweep results in resistance peaks at different gate potentials. This can likely be attributed to the hysteresis that exists in IL gating. Ions of IL are relatively large (˜10 Å) and may easily adsorb onto the graphene surface.

An additional amount of gate voltage may be required for ions to desorb. One other effect present is the potential required to shift the graphene Fermi level to the Dirac point. In this instance, ˜+1570 mV is required. This can be explained partially by the fact that there is no RE to offer a potential standard. The exact potential value of the graphene is sensitive to grounding conditions and the precision of the op-amp-based measurement circuit downstream.

However, as Applicants have seen in the switch from an aqueous Ag/AgCl reference electrode to a solid state pseudo reference electrode, the potential shift is on the order of 0.1 V. It could not fully account for the ˜1.6 V potential shift observed. Peng et al. showed that when graphene is in contact with a metal it is n-doped. However, it does not fully compensate for the p-doping caused by the chemical vapour deposition (CVD) process that synthesizes the graphene. This explains the need to apply an additional positive gate voltage to increase the charge carrier density of graphene thereby shifting the Fermi level up to reach the Dirac point.

An experiment is performed to measure the resistance of graphene over time while adding IL to the sample. No gate (CE) voltage is applied. This allows for the comparison of graphene resistance in air vs. in IL.

FIG. 12C, 12D are plots showing resistance vs time of graphene samples 1 and 2, respectively. Gray data points indicate resistance measured in air, blue data points represent resistance measured when graphene is in contact with ionic liquid but with counter electrode disconnected. Gray shaded region and vertical dotted line represent the time when ionic liquid droplet is added.

Similar to the experiment of FIG. 9, an irreversible increase of graphene resistance is observed. This result eliminates the possibility of the IL introducing significant additional conduction pathways parallel to the graphene sheet as this will cause a decrease in the measured resistance as opposed to the increase in resistance as observed.

Applicants can attribute the resistance increase to IL adsorbing on the graphene surface. In view of the possibility that the presence of metallic electrodes p-dope the graphene, we can hypothesize that the DEME⁺(Diethylmethyl(2-methoxyethyl)ammonium) ions are preferentially adsorbed to explain the shift in Fermi level towards the Dirac point.

### Cyclic Voltammetry and Simultaneous Resistance Measurement of Graphene Sample

FIG. 13A, 13B shows the simultaneous cyclic voltammetry and conductance measurement of a graphene as the working electrode with 1.0 mM cobaltocene in DEME-TFSI at room temperature. In FIG. 13A, current peaks corresponding to redox reactions can be observed at similar potential compared to FIG. 4C. In FIG. 13B, conductance (reciprocal of resistance) is plotted against the counter electrode potential. There is a significant background conductance change due to the shift of the graphene Fermi level similar to that of FIG. 12B. The applicants observe a valley in conductance (peak in resistance) at around +750 mV and +1000 mV of counter electrode potential (vs. Ag/AgCl) which corresponds to hybridization of the cobaltocene molecule wavefunction with that of graphene.

### Variant Embodiments

A proposed variation can include performing CV using graphene as the WE. CV experiments have been performed to characterize the electrochemical property of graphene. A proposed variation can include simultaneous resistance measurements of graphene as CV is performed. Graphene CV and conductance data are shown in FIG. 13A and FIG. 13B.

In another variation, the substrate can be switched to degenerately doped Si with 300 nm SiO₂ and measurements can be performed using the new substrate. The enhanced optical contrast of the 300 nm oxide layer facilitates a new characterization technique of graphene—Raman spectroscopy. Raman spectroscopy has proven to be a very versatile tool for identifying the quality and number of layers of a graphene sample. There are two significant peaks in the Raman spectrum. One is at 1587 cm⁻¹ known as the G-band. It can be attributed to the in-plane vibration of sp² bond of carbon atoms. Another is the 2686 cm⁻¹ 2D-band which accounts for the out-of-plane vibration. The 2D band is suppressed if the sample has more graphene layers and the G band is enhanced for more layers.

Another potential feature of this variation is that it enables double gate experiments. The top CE and RE enable CV, interaction between redox species and graphene, and therefore gating of graphene resistance. Silicon enables application of a back gate voltage (amplified by a voltage amplifier) and therefore bottom gating and shifting of graphene energy levels, including the Fermi level. Using a PPMS, one can perform cryogenic double gate measurements. One can make a PCB design to utilize surface mount technology and improve the general robustness of the test and measurement circuitry.

A goal of this approach is to measure resistance vs temperature for different CV voltage (shifting molecule energy level and oxidation state), back gate voltage (shifting graphene energy levels) and different molecules (ferrocene and cobaltocene).

Another potential variation that different 2-d materials may be used, including different metals, semiconductors, semi-metals, superconductors, and van der Waals materials (monolayers, nanosheets and stacks). For example, with respect to van der Waals materials, the invention may use other materials besides graphene such as transition metal dichalcogenides. Variations may use multiple 2-d materials in a stacked fashion orientation. These may include multilayers of graphene, which may be twisted with respect to each other. They may also include a large number of layers, as in graphite and other 2-d van der Waals materials.

In summary, Applicants provided an overview of the common three methods of gating the resistance of a material, namely electrostatic, electrolyte and electrochemical gating. Experimental techniques were discussed in regards to the following two techniques: 4 probe resistance measurements and cyclic voltammetry.

Applicants integrate the two techniques, combined with innovations, including but not limited to control of the a dielectric layer, to make the charge exchange transistor apparatus. Using this apparatus, Applicants find evidence of a quantum transition state associated with redox charge transfer. This effect is measurable by the charge exchange transistor apparatus by monitoring the resistance of a thin film electrode while it is undergoing electrochemical reactions. Next, other variants are proposed to modify the charge exchange transistor method for use in cryogenic temperatures and to add a back electrostatic gate for additional control of its electronic properties. Cryogenic measurements enable one to minimize the effect of electron-phonon scatting and potentially unveil novel emergent phenomena. Preliminary experiments indicate that the cryogenic charge exchange transistor is viable and work is in progress toward measurements in PPMS™.

This line of work is significant and useful as it offers useful and novel methods and apparatii for tuning material resistance by a fundamentally quantum mechanical means. In addition, the evidence provided for a quantum transition state shows that the the methods and apparatii presented deepen an understanding of how charges are transferred in an electrochemical reaction. The charge exchange transistor tool and method Applicants developed are further useful as they probe interaction between localized states of d or f orbitals with the delocalized band states, which is of fundamental importance to strongly correlated electron systems that show a range of non-trivial emergent phenomena. The ability of the charge exchange transistor tool and method to probe surface interactions between molecules in solution and solid surfaces points to the possibility of using it to characterize/monitor the performance of electrocatalysts and detect catalyst poisons as well as various metals, the development of which could tackle significant issues such as clean energy and climate change.

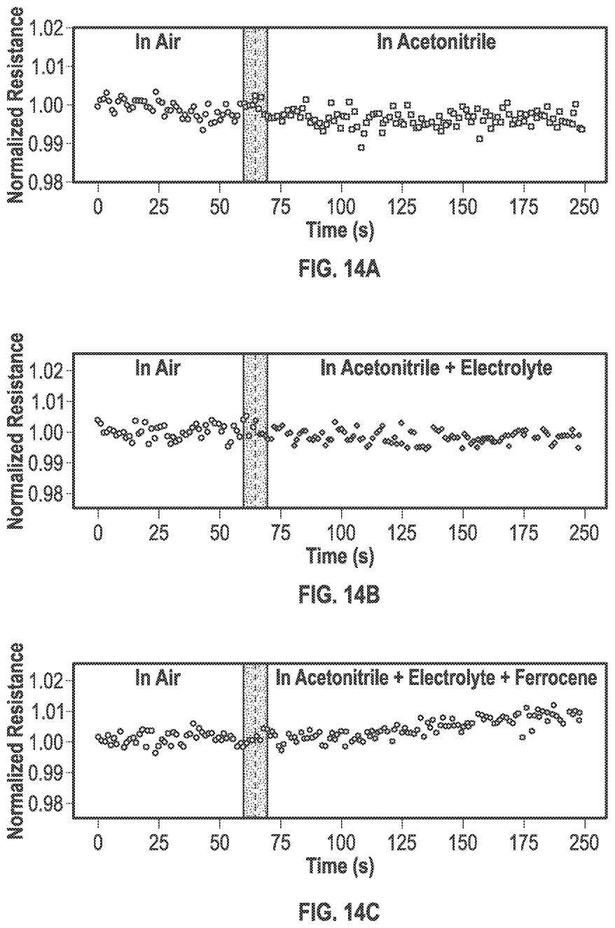

FIGS. 14A-14C is a set of control measurements. Normalized Au film resistance in air (0 s to 65 s) and various solutions (65 s to 200 s) with no voltage applied to the counter electrode. Resistance measured in air then upon immersion in: FIG. 14A, Acetonitrile. FIG. 14B, Acetonitrile-tetrabutylammonium hexafluorophosphate electrolyte solution. FIG. 14C, Acetonitrile-tetrabutylammonium hexafluorophosphate electrolyte-ferrocene solution. Gray shaded regions represent time to fill the electrochemical cell. The film exhibits no significant change in resistance when immersed in these various solutions. Accordingly, resistance peaks observed in CV measurements can not be attributed to a presence of the solvent or to the various species in solution.

FIGS. 15A-15F show cyclic voltammetry and simultaneously measured working electrode resistance with and without hexanethiol monolayer varying potential sweep rate. FIG. 15A, CV of ferrocene in solution at sweep rates of 50, 100, 200 and 400 mV/s. A bare Au film serves as the working electrode. FIG. 15B-FIG. 15E are plots showing normalized bare Au film resistance vs. potential. Resistance measurements exhibit large peaks whose magnitudes are not strongly affected by varying sweep rate. FIG. 15F is a plot of Redox current vs (Sweep rate)^{0.5} using data from a, The observed linear behaviour is consistent the Randles-Sevcik equation. FIG. 15G is a CV of ferrocene in solution at sweep rates of 50, 100, 200 and 400 mV/s. A Au film with a hexanethiol monolayer serves as the working electrode. FIG. 15H-15K are plots showing Normalized film resistance vs. potential. Resistance peaks are strongly attenuated compared to those observed using a bare Au film as a working electrode. FIG. 15I is a plot of Normalized bare Au film resistance peak magnitude vs (Sweep rate)^{0.5} using data from FIG. 15B-15E. Resistance peak magnitudes do not exhibit significant dependence on potential sweep rate.

FIGS. 16A-16C are a set of drawings showing Projected density of states (PDOS) for Fe, C and H atoms in an isolated ferrocene molecule calculated using DFT. FIG. 16A is a PDOS for Fe atom. FIG. 16B is a PDOS for C atoms. FIG. 16C is a PDOS for H atoms. Discrete energy levels can be observed. The PDOS calculation results agree well with literature results.

FIGS. 17A-17C is a set of drawings showing PDOS for Au slabs of different sizes containing, at FIG. 17A, 49 atoms, at FIG. 17B, 160 atoms and at FIG. 17C, 490 atoms. The PDOS for the three Au slabs exhibit similar shapes and resemble that of bulk Au and thin Au films. The DOS in the energy range of ˜−8 eV to ˜−2 eV corresponds to the Au 5d band.

### Definitions

The term “connected” or “coupled to” may include both direct coupling (in which two elements that are coupled to each other contact each other) and indirect coupling (in which at least one additional element is located between the two elements).

Although terms such as “maximize”, “minimize” and “optimize” may be used in the present disclosure, it should be understood that such term may be used to refer to improvements, tuning and refinements which may not be strictly limited to maximal, minimal or optimal.

The term “connected” or “coupled to” may include both direct coupling (in which two elements that are coupled to each other and contact each other) and indirect coupling (in which at least one additional element is located between the two elements).

The term “substantially” as used herein may be applied to modify any quantitative representation which could permissibly vary without resulting in a change in the basic function to which it is related.

Terms such as “up to”, “at least”, “greater than”, “less than”, “more than”, “or more”, and the like, include the number recited and such terms refer to ranges that can be subsequently broken down into sub-ranges. In the same manner, all ratios recited herein also include all sub-ratios falling within the broader ratio.

The singular forms “a,” “an,” and “the” include the plural reference unless the context clearly dictates otherwise. The term “and/or” means any one of the items, any combination of the items, or all of the items with which this term is associated.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended embodiments are intended to include within their scope such processes, machines, manufacture, compositions of matter, means, methods, or steps.

As can be understood, the examples described above and illustrated are intended to be exemplary only.

1. An apparatus for monitoring an impedance or a change in the impedance of a first material having a first material quantum state with a first material electron density distribution and at least one first material quantum energy level, the apparatus configured to receive in proximity with the first material a second material having a second material quantum state with a second material electron density distribution and at least one second material quantum energy level, wherein the first material is selected to have a first material quantum energy level for forming a hybridized quantum state with the second material,
the apparatus comprising:
a source probe configured for electrical contact with the first material and configured to apply a source electrical signal to the first material;
at least one gate electrode, configured to receive at least one gate electrical signal and to generate at least one gate electric field that shifts the at least one first material quantum energy level relative to the at least one second material quantum energy level, thereby modifying a hybridization between the first and second material quantum states and the first and second material electron density distributions;
a drain probe configured for electrical contact with the first material and configured to measure a response of the first material to the gate and source electrical signals, at least one of the gate and source electrical signals having an alternating current (AC) component;
one or more processors configured to:
receive data comprising the response from the drain probe,
determine the impedance or the change in the impedance of the first material upon measuring the response of the first material while the first material participates in one or more electrochemical reactions, the impedance or the change in impedance of the first material electrode established at least partially based upon the hybridization between the first and second material quantum states;
determine a material characteristic of the second material based on at least one of the impedance or the change in the impedance of the first material.

2. The apparatus of claim 1, wherein the first material includes or is coupled with a first dielectric layer adapted for enabling the hybridization of the first and the second material quantum state.

3. The apparatus of claim 2 wherein the at least one gate electrode comprises an back gate electrode for inducing a redox change in the second material; wherein the processor is configured to measure a back gate voltage at which the redox change occurs to determine the material characteristic of the second material, wherein the dielectric layer is selected to enable at least one gate electric field to shift the at least one first material quantum energy level relative to the at least one second material quantum energy level for a charge sharing between the first and second material.

4. The apparatus of claim 3, wherein a second dielectric layer is positioned between the back gate electrode and the first material, wherein the second dielectric layer is a solid state material comprising SiO, wherein the back gate comprises silicon and the first material comprises graphene.

5. The apparatus of claim 1, wherein the first material comprises a coating comprising a functional group.

6. The apparatus of claim 5, wherein the coating comprises at least one of an alkane, a carboxylic acid group, a diazonium functional group, an amine group, an alcohol group, a phenyl group, and a thiol functional group.

7. The apparatus of claim 6, wherein the coating comprises: at least one of an n-alkanethiol monolayer, wherein n is greater than equal to 2 and less than equal to 7; thiomalic acid; mercaptobenzoic acid; 2-aminoethanethiol; 3-mercaptopropanol; cysteine; 3-mercaptopropanoic acid; and 11-mercaptoundecanoic acid.

8. The apparatus of claim 5, wherein the coating is configured to position the second material a distance from the first material, wherein the distance between the first material and the second material is less than 10 nm, preferably the distance is less than or equal to 1 nm, more preferably the distance is about 0.5 nm, still more preferably the distance is about 0.25 nm.

9. The apparatus of claim 5, wherein the source probe is a first source probe, wherein the at least one gate electrode is at least one first gate electrode, wherein the drain probe is a first drain probe, and wherein the apparatus comprises:
a second source probe configured for electrical contact with a third material and configured to apply a source electrical signal to the third material;
at least one second gate electrode, configured to receive at least one second gate electrical signal and to generate at least one second gate electric field that shifts the at least one third material quantum energy level relative to the at least one second material quantum energy level, thereby modifying a hybridization between the third and second material quantum states and the third and second material electron density distributions;
a second drain probe configured for electrical contact with the third material and configured to measure a response of the third material to the second gate and second source electrical signals, at least one of the second gate and second source electrical signals having an alternating current (AC) component;
wherein the processor is configured to:
determine the impedance or the change in the impedance of the third material upon measuring the response of the third material while the third material participates in one or more electrochemical reactions the impedance or the change in impedance of the third material electrode established at least partially based upon the hybridization of the third material and the second material quantum states between the third material and the second material; and
determine the material characteristic of the second material based on at least one of the impedance or the change in the impedance of the first material and third material.

10. The apparatus of claim 1, wherein the first material has a thickness of less than or equal to 10000 nm, preferably the first material has a thickness of less than or equal to 1000 nm, more preferably the first material has a thickness of less than or equal to 100 nm, still more preferably the first material has a thickness of less than or equal to 10 nm.

11. The apparatus of claim 1, comprising a reference electrode in electrical contact with the gate electrode.

12. The apparatus of claim 1, wherein monitoring the impedance or the change in impedance of the first material comprises:
monitoring at least one of a conductance, capacitance, and resistance; or
a change in the conductance, capacitance, and resistance of the first material.

13. The apparatus of claim 1, wherein the second material comprises at least one of ferrocene, cobaltocene, heavy metals, iron, catalyst poison, and metal ions.

14. The apparatus of claim 1, wherein the first material comprises at least one of transition metal dichalcogenides, graphite, graphene, carbon, platinum, titanium, chromium, and gold.

15. The apparatus of claim 1, wherein the second material is in a medium comprising ions.

16. A method of monitoring an impedance or a change in the impedance of a first material, the method comprising:
providing the apparatus of claim 1;
providing the second material in proximity to the first material;
applying an AC current to the first material;
determining the impedance or the change in the impedance of the first material;
determining the material characteristic of the second material.

17. The method of claim 16, comprising applying a ramping voltage to the gate electrode.

18. The method of claim 16, comprising sending a report dataset comprising the material characteristic to a task scheduler system for automatic schedule investigation of a test site.

19. The method of claim 16, wherein the material characteristic comprises an amount of the second material, the method comprising: determining if the amount of the second material is greater than a threshold amount of the second material; and issuing an alert.

20. The method of claim 16, comprising measuring the impedance at a gate voltage when redox of the second material occurs; and identifying the second material based on the measured impedance at the gate voltage.
